(19) United States
(12) Patent Application Publication
(10) Pub. No.: US 2012/0174464 A1
(43) Pub. Date: Jul. 12, 2012

(54) HIGH EFFICIENCY, HIGH STABILITY, MULTI-ELEVATION TRAWL DOOR AND METHODS

(76) Inventor: Sherif Safwat, Bainbridge Island, WA (US)

(21) Appl. No.: 13/496,172

(22) PCT Filed: Sep. 14, 2010
(86) PCT No.: PCT/EP2010/063499

§ 371 Date: Mar. 14, 2012

Related U.S. Application Data
(60) Provisional application No. 61/276,611, filed on Sep. 14, 2009.
(60) Provisional application No. 61/335,143, filed on Jan. 2, 2010.
(60) Provisional application No. 61/343,323, filed on Apr. 27, 2010.

(51) Int. Cl. A01K 73/04

(52) U.S. Cl. 43/9.7

(57) ABSTRACT

An improved trawl door that provides by combination of certain camber relationships of leading edge slats relative to a main deflector body, in certain aspect ratios, with certain thickness relationships for plates forming leading edge slats and a main deflector body where such leading slats and such main deflector body are formed with a similar curvature to their exterior (i.e. “outer”) and interior (i.e. “inner”) side surfaces, a trawl door that provides a maximally efficient trawl door of superior efficiency, of superior stability, useful at a wide range of angles of attack. In certain embodiments a perforate slat is disposed above a leading edge slat. In certain other embodiments, a perforated slat is disposed above a main deflector body, and certain constructions of support plates are useful for protecting the various perforated slats.

### TECHNICAL FIELD

The present disclosure relates generally to trawl doors used in trawl fishing, seismic surveillance line spreading and spreading of other items towed in water and, more particularly, to trawl doors adapted for more stable, more efficient operation at all angles of attack, including large and small angles of attack, while also being useful at both shallow water trawl fishing applications as well as deep water trawl fishing applications, and while also being useful at bottom trawl fishing applications as well as at pelagic trawl fishing applications.

### BACKGROUND

A main problem in the use of trawl doors to spread open the mouth of a trawl net is that, despite various claims, no one single trawl door has been proposed that can operate with maximal efficiency at both very shallow depths, for example depths of less than twenty fathoms, and also at very deep depths, for example depths exceeding 150 fathoms. Furthermore, also despite various claims, no one single trawl door has been proposed that can operated efficiently and reliably in all the rigors of bottom trawling while also being sufficiently efficient to be useful in pelagic trawl fishing operations.

As a result of the failure of the known art to provide such a trawl door, fishing companies more often than not are forced to expend additional resources acquiring several sets of trawl doors in order to permit their various fishing operations for various species of pelagic fishes. I.e. fishes fished for at rather shallow depths and at rather deep depths, and also to allow them to operate both with bottom trawls as well as with pelagic trawls.

Due to the constantly increasing costs of operating commercial trawlers, often in the presence of quantified catch quotas, it is increasingly important to increase the efficiency of the fishing equipment so as to permit harvesting allocated catch quotas with a minimal of effort, and especially with a minimal of fuel. As the drag of trawl doors provides for a large quotient of the drag experienced by a trawler during trawl fishing operations, it is always important to increase the efficiency of trawl doors, so as to minimize drag and fuel consumption requirements. It also is an object of the present disclosure to provide for a maximally efficient trawl door, and especially a trawl door that shows during actual trawling operations bettered spread of a trawl net, and/or bettered distance between trawl doors (as important in some fisheries), and/or reduced drag.

Furthermore, as without a maximally stable trawl door, efficiencies of trawl doors are unable to be realistically utilized during actual trawl fishing operations, it is another object of the present disclosure to provide for a trawl door that exhibits bettered stability. One measure of bettered stability for the purposes of the instant disclosure is a trawl door that exhibits superior lift at a greater range of angles of attack compared to a version of at trawl door exhibiting yet more superior or similar lift at a narrower range of angles of attack, as the variations in cross currents, and constant turning of fishing trawlers constantly alters trawl door angle of attack, as does the variation in trawl net loading and drag from the towed trawl net.

None in the art have proposed a trawl door having the particular characteristics of the trawl doors of the present disclosure.

Furthermore, it is worthwhile to note that the present state of the art and current trend in the industry in trawl fishing and especially in forming trawl doors for trawl fishing is that when forming trawl doors from bent steel plates, the plates have a same or similar thickness in all portions of the trawl door. Occasionally, secondary and localized reinforcement plates are added to protect the trawl door's plates against abrasion that wears through the steel. However, these reinforcement plates only cover a minority of the plate being reinforced, whether that plate is a main deflector or any type of slat, i.e. a leading slat or a trailing slat. Thus, the present trend in the industry and the state of the art is that when forming trawl doors from bent steel plates, that the plates forming the main deflector and the leading slats have a similar including same thickness. Furthermore, the state of the art and trend in the industry is either to add extra reinforcement to a forward leading edge slat on a trawl door, or that a forward leading edge slat on any trawl door shall be formed from a strongest and thickest bent steel plate on a trawl door, and formed of a thicker plate of steel that is subsequently bent than is formed either a main deflector or another slat, such as a trailing leading edge slat.

It also is worthwhile to note that another present state of the art and current trend in the industry is that when forming trawl doors from bent steel plates, should any foil of a trawl door be partially formed of a thicker bent steel plate than other portions of other foils present in the trawl door, it is the present state of the art and the current trend in the industry to form a leading edge slat and especially a forward leading edge slat having portions formed of a thicker bent steel plate (including laminated bent steel plates) compared to the thickness of a bent steel plate forming either a trailing leading edge slat or forming a main deflector. These reinforcement plates presently are in place to improve durability of the trawl door, with the present state of the art and the current trend of knowledge in the industry being that such configurations also provide for a maximally efficient trawl door.

While trawl doors having profiles for a trawl door's main deflector as well as for a trawl door's leading edge slats that are formed of bent plates or airfoil shaped profiles are known, and while trawl doors having profiles of the main deflector formed of an airfoil profile combined with profiles of at least one leading slat formed of a bent plate also are known, none in the art have proposed trawl door profiles as taught herein. In respect to trawl doors having profiles including a main deflector as well as one or more leading edge slats formed of airfoil shapes, it is the present state of the art and the current trend in the industry that when a leading edge slat and especially that when a forward leading edge slat is formed with an airfoil profile, that shall include a profile where the camber of the inner and outer side surfaces of a cambered slat or a cambered deflector are not the same, that the leading edge of the forward leading edge slat be disposed below an imaginary straight line (including the axis of an imaginary straight line) joining leading and trailing edges of the trawl door's main deflector. Historical trawl doors including seismic deflectors that include several foils of same or similar profile and having same or similar distances between the leading and trailing edges of various of the multiple foils able each to be considered as “main deflectors” are not to be confused with trawl doors of the present disclosure.

It also is worthwhile to note that the present state of the art and the current trend in the industry is to minimize the amount of steel used in any particular trawl door. Therefore, one of the current states of the art and one of the current trends in the industry is to minimize the dimensions of support plates used in trawl doors, such as upper and lower end plates, and also central support plates to which usually affix main brackets (also known as main bales or “bales”), to which ultimately are fixed main warp connection points.

Published Patent Cooperation Treaty (PCT) International Publication Number WO 2006/011163 A3, International Application Number PCT/IS2003/000025 that is entitled “High Speed, Increased Hydrodynamic Efficiency, Light-Weight Molded Trawl Door and Methods for Use and Manufacture” describes molding portions of a trawl door's body from a synthetic material able to receive impacts fracture free, with a preferred profile being a particular airfoil profile in combination with a variety of leading edge slats, and in some cases also trailing edge slats.

Published Patent Cooperation Treaty (PCT) International Publication Number WO 2006/048258 A1, International Application Number PCT/EP2005/011722 that is entitled “Higher Efficiency Pelagic Trawl Door Construction Employing Universally Available Materials and Methods” describes a dihedral trawl door construction of a certain range of aspect ratios having a certain variety of arrangement of leading edge slats able to provide higher efficiency than earlier known trawl door constructions, especially being superior at spreading horizontally apart the mouth of a trawl net in actual trawl fishing applications compared to non dihedral doors of similar aspect ratios.

Published Patent Cooperation Treaty (PCT) International Publication Number WO 2008/129068 A1, International Application Number PCT/EP2008/054958 that is entitled “Perforated Slat Trawl Door” describes a trawl door having a perforated plate forming a perforated slat disposed relative to the trawl door's main deflector body in a specific arrangement, with a specific construction and perforation density of the perforated slat such that trawl door stability is dramatically improved, trawl door range of use and turning ability and cross current toleration ability are dramatically improved and trawl door turbulence and noise are dramatically reduced. Trawl door efficiency is also improved.

Published Patent Cooperation Treaty (PCT) International Publication Number WO 2009/016224 A1, International Application Number PCT/EP2008/060045 that is entitled “High Stability, High Efficiency Trawl Door and Methods” describes a trawl door having a particular profile with a particular arrangement of leading edge slats relative to a main deflector body and particular angles of inclination of such leading edge slats, providing for a profile for a trawl door of superior efficiency compared to earlier trawl doors, and useful in certain aspect ratios, and useful in dihedral trawl door constructions.

Nonetheless, none of the known art has proposed a trawl door that solves the problems and satisfies the needs mentioned herein, and none of the known art teaches a trawl door constructed and configured as a trawl door of the present disclosure.

Thus, there exists a long felt need in the industry for a trawl door able to be efficiently and practically used both in bottom trawl fishing applications as well as in pelagic trawl fishing applications.

Thus also, there exists a long felt need in the industry for a highly efficient trawl door that is more efficient than known trawl doors.

Thus also, there exists a long felt need in the industry for a highly efficient trawl door that is more efficient than known trawl doors and that also is stable at a wide range of angles of attack, and that also is able to be used at both relatively shallow depths as well as at relatively deep depths, and at all depths in between.

Furthermore, it can be appreciated that there exists a demand in the industry for a trawl door that satisfies the above stated long felt needs and that also operates well at both relatively slow speeds, such as at speeds lesser than two and a half knots, as well as at relatively fast speeds, such as at speeds exceeding five knots, while also being economical to manufacture and use.

### DEFINITIONS

ASPECT RATIO: means the Trawl Door Height relative to the Trawl Door Width. For example, a trawl door having a trawl door height of two (2) meters and a trawl door width of one (1) meter has an Aspect Ratio of 2:1 (two to one).
PROFILE: means the cross-sectional shape of a trawl door, or of a portion of a trawl door, viewed in a plane that is oriented perpendicularly across the trawl door's vertical dimension.
TRAWL DOOR: means any of a variety of essentially rigid structures having generally rigid deflectors (e.g. not formed of a foldable fabric as a kite) that is adapted for deployment in a body of water behind a towing vessel. More specifically, trawl door means any generally wing shaped and/or fin shaped device used to spread either a fishing net, such as a trawl, or to spread a seismic surveillance array and/or seismic array, such as used in making acoustic surveillance of a sea floor and sub-sea-floor, or to spread apart any other towed item, whether in air or sea. A trawl door usually attaches at a fore end to a terminal end of a main towing warp or other towing line depending from the towing vessel, and at an aft end to at least one other line itself ultimately attached to another towed item. In operation, trawl doors convert a portion of forward motion and/or energy imparted by the towing vessel into horizontally directed force for the purpose of spreading in a generally horizontal direction a trawl, seismic surveillance towed array complex, paravane line or the like.
TRAWL DOOR HEIGHT: is defined by the shortest distance between the trawl door's upper edge and the trawl door's lower edge and does not include a weight shoe or similar structure but rather relates only to that portion of a trawl door's structure that is intended to efficiently generate lift and/or thrust.
TRAWL DOOR WIDTH: is defined as the shortest distance between the trawl door leading and trailing edges as taken from a profile of the widest portion of that portion of the trawl door's structure intended to efficiently generate lift and/or thrust.

### DISCLOSURE

It is an object of the present disclosure to provide a trawl door that is able to be efficiently and practically used both in bottom trawl fishing applications as well as in pelagic trawl fishing applications.

It is another object of the present disclosure to provide a highly efficient trawl door that is more efficient than known trawl doors.

It is yet another object of the present disclosure to provide a trawl door that is more efficient than known trawl doors and that also is stable at a wide range of angles of attack.

It is yet another object of the present disclosure to provide a trawl door that is more efficient than known trawl doors, that is stable at a wide range of angles of attack and that also is able to be used at both relatively shallow depths as well as at relatively deep depths, and at all depths in between.

It is yet another object of the present disclosure to provide a trawl door that exhibits the above stated properties and that also operates well at both relatively slow speeds, such as at speeds lesser than two and a half knots, as well as at relatively fast speeds, such as at speeds exceeding five knots, while also being economical to manufacture and use.

It is an object of the present disclosure to teach a trawl door construction and methods for use that meets the above stated objects and needs of the industry.

Briefly, the trawl door of the present disclosure is able to provide by combination of certain camber relationships of leading edge slats relative to a main deflector body, in certain aspect ratios, with certain thickness relationships for plates forming leading edge slats and a main deflector body where such leading edge slats and such main deflector body are formed with a similar curvature to their exterior (i.e. “outer”) and interior (i.e. “inner”) side surfaces, a trawl door that provides a maximally efficient trawl door of superior efficiency, of superior stability, useful at a wide range of angles of attack and yet more especially when used in combination with the combinations of aspect ratios and dihedral trawl door construction as taught in that published PCT entitled “High Stability, High Efficiency Trawl Door and Methods”.

In another embodiment, the trawl door of the present disclosure is able to provide by combination of certain camber relationships of leading edge slats relative to a main deflector body, in certain aspect ratios, with certain thickness relationships for plates forming leading edge slats and a main deflector body where such leading edge slats and such main deflector body are formed with a similar curvature to their exterior (i.e. “outer”) and interior (i.e. “inner”) side surfaces, a trawl door that provides a maximally efficient trawl door of superior efficiency, of superior stability, useful at a wide range of angles of attack especially when used in combination with the perforated slat of the published PCT application entitled “Perforated Slat Trawl Door” and yet more especially when used in combination with the combinations of aspect ratios and dihedral trawl door construction as taught in that published PCT entitled

### “High Stability, High Efficiency Trawl Door and Methods”.

In yet another embodiment, the present disclosure a trawl door is provided with a forward perforated slat constructed similarly to that perforated slat taught in that published PCT application entitled “Perforated Slat Trawl Door” but rather than disposed outboard of, adjacent to and removed from the main deflector being disposed outboard of, removed from and adjacent to a leading edge slat, and preferably a forward leading edge slat. When combined with certain other features of the disclosed trawl door, including certain constructions of support plates, and certain camber relationships of leading edge slats relative to a main deflector body, and in some cases certain aspect ratios, such a trawl door satisfies all the objects of the present disclosure.

Due to the disclosed trawl doors improved efficiency and improved stability, it possesses the ability to be efficiently and practically used both for bottom trawl fishing as well as for pelagic trawl fishing.

Another advantage of the disclosed trawl door is that it possesses the ability to be efficiently and practically used at both relatively shallow depths as well as at relatively deep depths and at all depths in.

Yet another advantage of the disclosed trawl door is that it possesses the ability to be efficiently and practically used at relatively slow tow speeds as well as at relatively fast tow speeds.

Yet another advantage of the disclosed trawl door is that it possesses the ability to be efficiently and practically used at a wide range of angles of attack including relatively shallow angles of attack as well as relatively great angles of attack.

Yet another advantage of the disclosed trawl door is that it possesses the ability to be efficiently and practically manufactured and deployed, thereby reducing costs to produce and acquire the trawl door.

Yet another advantage of the disclosed trawl door is that it possesses the ability to allow a fishing vessel to operate with only one set of trawl doors for all its variety of trawl fishing needs, thereby reducing costs to operate the fishing vessel.

Possessing the preceding advantages, the trawl door answers needs long felt in the industry.

It can readily be appreciated that these and other features, objects and advantages are able to be understood or apparent to those of ordinary skill in the art from the following detailed description of the preferred embodiment as illustrated in the various drawing figures.

### BRIEF DESCRIPTION OF DRAWINGS

FIG. 1 is a plan view of the inner side of a trawl door of the present disclosure, that preferably is a Vee shaped (i.e. dihedral) trawl door;

FIG. 2 is front side view of a trawl door of the present disclosure, illustrating the preferred Vee shaped (i.e. dihedral) construction of the trawl door;

FIG. 3 is a planar cross sectional diagram taken along the line 3-3 in FIG. 1 illustrating a trawl door profile exemplifying one particular type of trawl door configuration to which the present disclosure is applicable for which the leading slats and the main deflector body have arcuate profiles, with various important distances, important linear axes and important angles of inclination being depicted, with optional perforated slats being associated with the forward leading edge slat and with the main deflector body as empirically determined useful as disclosed;

FIG. 4 is a planar cross sectional diagram taken along the line 3-3 in FIG. 1 illustrating another type of trawl door profile exemplifying one particular type of trawl door configuration to which the present disclosure is applicable for which the leading slats and the main deflector body have arcuate profiles having differing thicknesses;

FIG. 5 is a planar cross sectional diagram taken along the line 3-3 in FIG. 1 illustrating another type of trawl door profile exemplifying one particular type of trawl door configuration to which the present disclosure is applicable for which the leading slats and the main deflector body have arcuate profiles having differing thicknesses;

FIG. 6 is a planar cross sectional diagram taken along the line 3-3 in FIG. 1 illustrating another type of trawl door profile exemplifying one particular type of trawl door configuration to which the present disclosure is applicable for which the leading slats have arcuate profiles and the main deflector body has an airfoil shaped profile;

FIG. 7 is a planar cross sectional diagram taken along the line 3-3 in FIG. 1 illustrating another type of trawl door profile exemplifying one particular type of trawl door configuration to which the present disclosure is applicable for which a leading slat and the main deflector body both have an airfoil shaped profile and both have a perforated slat associated with them;

FIG. 8 is a planar cross sectional diagram taken along the line 3-3 in FIG. 1 illustrating another type of trawl door profile exemplifying one particular type of trawl door configuration to which the present disclosure is applicable for which a leading slat has an airfoil profile and the main deflector body has an arcuate shaped profile, that is most applicable at trawling angles of attack and some seismic angles of attack;

FIG. 9 is a planar cross sectional diagram taken along the line 3-3 in FIG. 1 illustrating another type of trawl door profile exemplifying one particular type of trawl door configuration to which the present disclosure is applicable for which a leading slat has an airfoil profile and the main deflector body has an arcuate shaped profile, that is most applicable at seismic angles of attack and may be useful at very high speed trawling angles of attack;

FIG. 10 is a planar cross sectional diagram taken along the line 3-3 in FIG. 1 illustrating another type of trawl door profile exemplifying one particular type of trawl door configuration to which the present disclosure is applicable that is similar to the profile illustrated in FIG. 3, and for which a preferred outline shape of trawl door support plates is super imposed on the profile;

FIG. 11 is a front view of a trawl door a trawl door of the present disclosure, illustrating the preferred Vee shaped (i.e. dihedral) construction of the trawl door having the support plates whose outline shape is shown in FIG. 10;

FIG. 12 is a schematic diagram of a back strop remotely controllable mechanism of the present disclosure for altering the angle of attack and optionally tilt angle of a trawl door of the present disclosure;

FIG. 13 is a schematic diagram of a main bracket/main warp attachment assembly remotely controllable mechanism of the present disclosure for altering the angle of attack and optionally the tilt angle of a trawl door of the present disclosure;

FIG. 14 is a side view of a portion of the mechanism shown in FIG. 13;

FIG. 15 is a schematic diagram of a main bracket/main warp attachment assembly remotely controllable mechanism of the present disclosure for altering the angle of attack of a trawl door and optionally also for altering the tilt angle of the trawl door of the present disclosure;

FIG. 16 is a schematic diagram viewed from the top side of another remotely controllable mechanism of the present disclosure for altering the attack angle and optionally the tilt angle of a trawl door of the present disclosure;

FIG. 17 is a schematic viewed from the front side of another remotely controllable mechanism of the present disclosure for altering the attack angle and optionally the tilt angle of a trawl door of the present disclosure;

FIG. 18 is a plan view of the back (outer) side of a trawl door of the present disclosure, illustrating another preferred Vee shaped (i.e. dihedral) construction of the trawl door of the present disclosure as used mainly for bottom trawling but also can be used for pelagic trawling, with various important backstrop attachment parameters depicted;

FIG. 19 is a front plan view the trawl door of the present disclosure illustrated in FIG. 18 and also illustrating the preferred Vee shaped (i.e. dihedral) construction of the trawl door of the present disclosure as used mainly for bottom trawling but also can be used for pelagic trawling, with various important backstrop attachment parameters depicted;

FIG. 20 is a planar cross sectional diagram taken along the line 3-3 in FIG. 1 illustrating another type of trawl door profile exemplifying one particular type of trawl door configuration to which the present disclosure is applicable for which the leading slats and the main deflector body have arcuate profiles and a half-pipe like side slat is associated with the upper and lower edges of the trawl door in place of planar support plates;

FIG. 21 is a front plan view of the trawl door having the profile illustrated in FIG. 20, and especially is mainly useful as a bottom trawl door but also can be used for pelagic trawling;

FIG. 22 is a top plan schematic view depicting offset arrangements for main deflector bodies forming another alternative trawl door construction of the present disclosure;

FIG. 23 is a general side plan view of the inner side of another trawl door construction of the present disclosure useful mainly in pelagic trawling but also can be used in bottom trawling, illustrating a preferred rigging configuration of the present disclosure for backstrops of the present disclosure.

### BEST MODE FOR CARRYING OUT THE DISCLOSURE

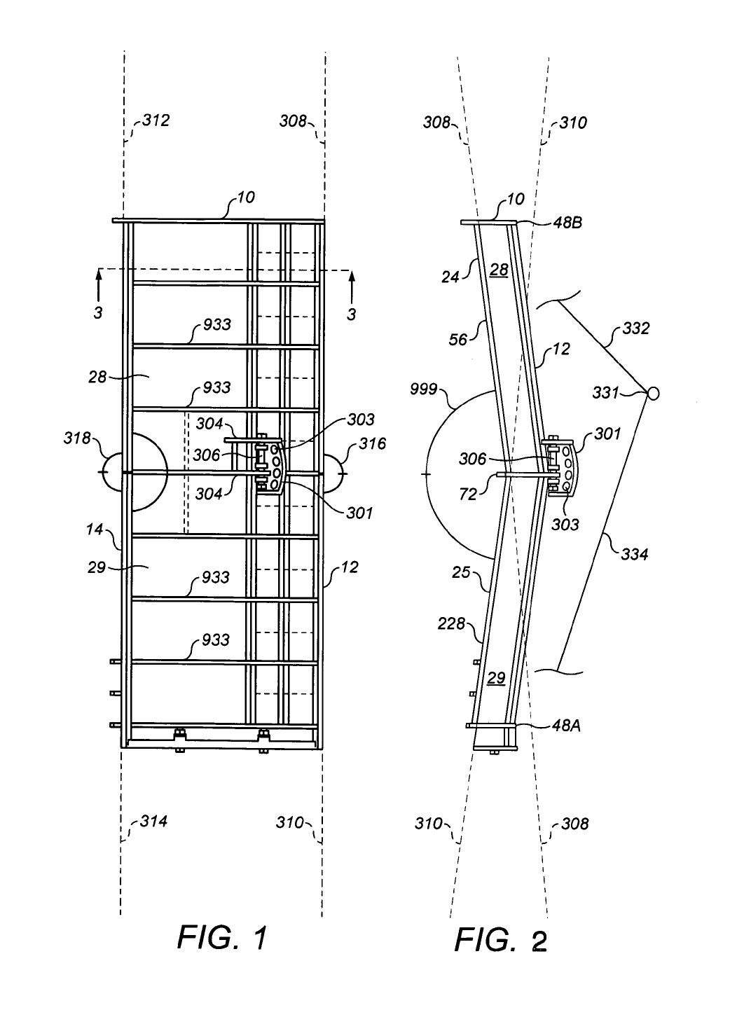

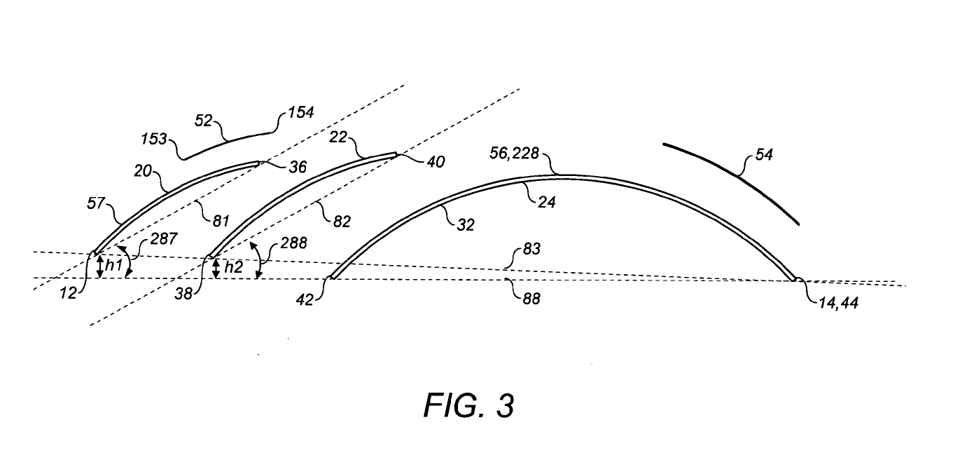

In Reference To FIGS. 1 and 2: A preferred trawl door for trawl fishing applications for the purpose of the present disclosure as well as for many other uses of a trawl door of the present disclosure is a Vee shaped, i.e. dihedral trawl door, identified in FIG. 1 and FIG. 2 by the general reference character 10. As illustrated in FIG. 2, the trawl door of the present disclosure includes upper and lower trawl door sections 28 and 29, each lying in different planes that diverge and have an included angle 999 measured between the outer side convex surfaces of the upper and lower trawl door sections 28 and 29, where the included angle is lesser than one hundred eighty degrees. In other terms, the included angle 999 also is measured between the outer side surfaces 56 and 228 (see also FIG. 3) of the upper and lower main deflector bodies 24 and 25 that are included within the upper and lower trawl door sections 28 and 29, respectively, and such included angle is lesser than one hundred eighty degrees. For the purposes of the present disclosure, the terms “main deflector body” and “main deflector” are the same.

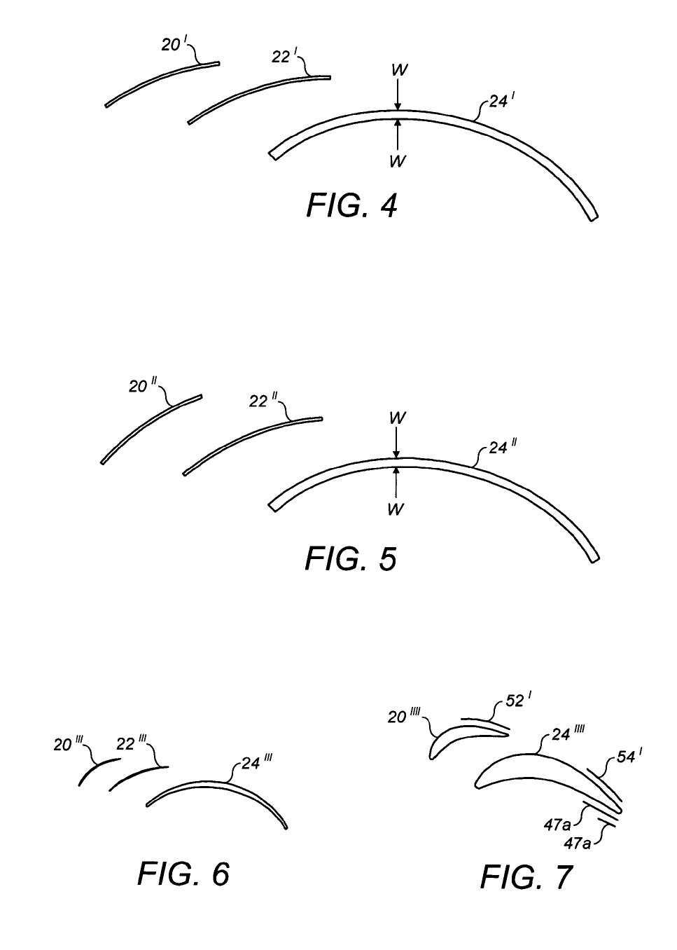

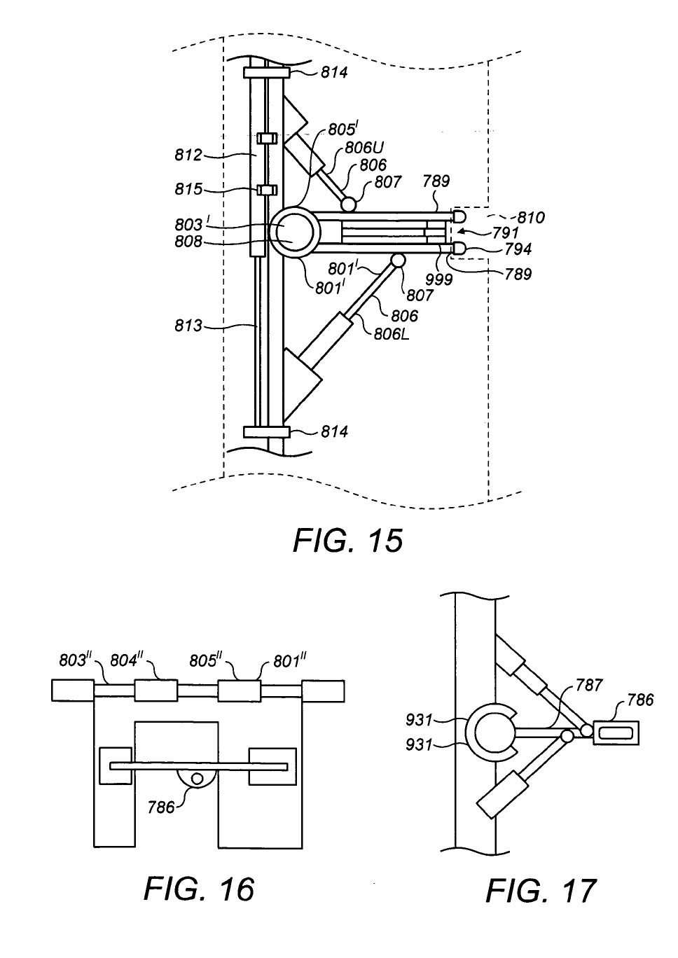

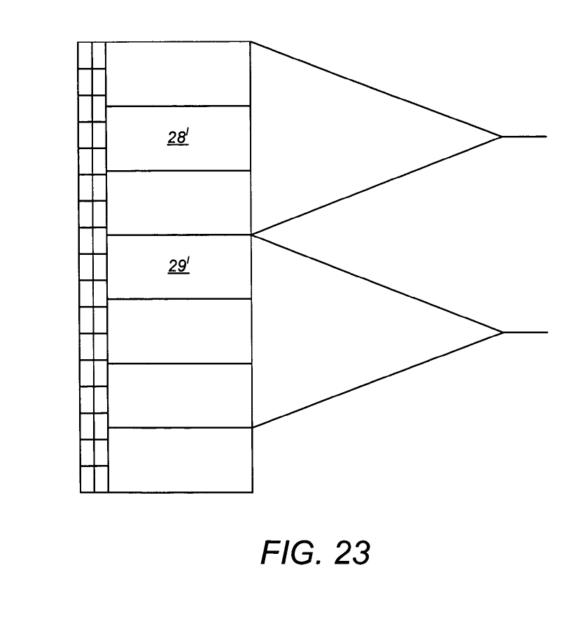

Those elements depicted in FIGS. 4 to 20 that are common to the trawl door profile illustrated in FIG. 3, those elements depicted in FIGS. 15 and 16 that are common to FIG. 13, and those elements depicted in FIG. 23 that are common to the trawl door illustrated in FIG. 1 to 2, carry the same reference numeral distinguished by a prime (“′”) designation.

FIG. 3 shows a profile for the trawl door of the present disclosure that is especially efficient at shallow, moderate as well as at high angles of attack and increases the range of use at which the trawl door of the present disclosure can ideally be used. To make the preferred embodiment of this profile, as shown the profile includes a forward leading edge slat 20 having a leading edge 12 and a trailing edge 36, where the leading edge 12 is not situated upon the axis of an imaginary straight line 88 connecting leading and trailing edges 42, 14 of the main deflector body 24, but that rather is situated above such straight line (it is understood in the art that the term “above” as used herein means being situated on a side of such straight line 88 that is a side including the profile of the main deflector and/or including a majority of the profile of the main deflector, rather than on another side of such straight line that is a side not including the profile of the main deflector and/or not including a majority of the profile of the main deflector). Furthermore, the profile includes trailing leading edge slat 22 having leading edge 38 and trailing edge 40, where the leading edge 38 also is not situated upon the axis of line 88, but also preferably is situated above line 88. When the forward and trailing leading edge slats 20 and 22 are each formed of a cambered plate, as shown, it is preferable that the leading edges of such forward and trailing leading edge slats are disposed above such line 88, as shown.

In other words, the portion of the trawl door having the profile is configured so that a line 83 joining leading and trailing edges 12, 14 of the trawl door and a line 88 joining leading and trailing edges 42, 14 of the main deflector body are not coaxial. Similarly, and preferably, the portion of the trawl door having the profile is configured so that a line joining leading edge 38 of the trailing leading edge slat and the trailing edge 14 of the main deflector body and the line 88 joining leading and trailing edges 42, 14 of the main deflector body are not coaxial.

For the purposes of the present disclosure, the term “cambered plate” in reference to the profile of any slat and/or main deflector of a trawl door of the present disclosure indicates that the profile of such slat and/or main deflector has same or similar cambers and/or curvatures for its outer and inner side surfaces. An arcuate shape is an example of such a profile, whether or not the profile is formed of a radius of a circle or any other arched shape or series of arched shapes. A cambered plate for the purposes of the present disclosure ideally is formed by bending a steel plate, that is by bending a sheet of steel. However, a cambered plate may be formed by bending any other sheet material, or by molding or casting a material into a form so that its final set phase has the same configuration and shape as a sheet material having been bent. Most ideally, the profile of any slat or main deflector of a trawl door of the present disclosure, when termed any or all of “bent sheet”; “bent sheet material”, “cambered plate” and/or “bent steel plate” and the like refers to the fact that in profile such slat and/or main deflector is not clearly airfoil in shape, but has a uniform and/or similar width as measured along a shortest distance from an inner side surface to an outer side surface anywhere along a portion of the majority of such slat's and/or main deflector's profile not necessarily including distal leading and trailing edges.

It is important to note that in the preferred trawl door of the present disclosure the trailing edge of the main deflector body and the trailing edge of the trawl door are the same, as indicated by reference numeral 14. However, the trailing edge of the trawl door in FIG. 3 also is indicated by reference numeral 44.

In the presently preferred embodiments of the present disclosure, it is preferred that:

the trawl door include at least one leading edge slat and only one main deflector;

that the profile of the trawl door and/or a profile of at least a portion of the trawl door have characteristics including that:

the main deflector has a chord direction line that is greater than a chord direction line of any of the leading edge slats. A “chord direction line” is an imaginary straight line joining leading and trailing edges of a main deflector and/or joining leading and trailing edges of a leading edge slat. That is to say, that a distance between leading and trailing edges of the main deflector, i.e. “the main deflector's chord direction line”, is greater than a distance between the leading and trailing edges of any leading edge slat, i.e. is greater than any leading edge slat's chord direction line; and

at least one of the leading edge slats has a leading edge that lies above strait line 88.

In these embodiments of the trawl door of the present disclosure, it is especially important that the leading edge of the forward leading slat, and also in certain embodiments (such as when the trawl door's aspect ratio exceeds 2:1) that the leading edge of a trailing leading slat also lie above the axis of such imaginary line 88 joining leading and trailing edges of the main deflector.

Furthermore, it is especially preferred for the various embodiments of the present disclosure that the trawl door combine a shape including upper and lower trawl door sections 28 and 29 that lie in different planes (see FIG. 2), i.e. to provide a Vee shape trawl door and/or any other dihedral form of trawl door (there can be multiple trawl door sections lying in different planes, for example, three or four trawl door sections, or more, each, several or all of which lie in different planes, though at present two sections is preferred.

When the trawl door's aspect ratio is lesser than 2:1 (two to one) and also lesser than 1.7:1 (one point seven to one), it is preferred that the trawl door include either two leading edge slats and/or at least two leading edge slats where a forward leading edge slat's leading edge lies further above the imaginary straight line joining leading and trailing edges of the main deflector than lies the leading edge of the trailing leading edge slat (including that the leading edge of a trailing leading edge slat may lie either directly on, below, or above such line 88 when the leading edge of the forward leading edge slat lies both above the leading edge of the trailing leading edge slat as well as above such line 88).

Importantly, the entire trailing edges 36 and 40 of the forward and trailing leading edge slats and in certain useful embodiments at least 4%, at least 7%, at least 15% and much more even exceeding 87% of each such leading edge slat's respective chord length project above a tangent plane of the outer side surface of the main deflector where such tangent plane is parallel to straight line 88. However, in certain embodiments the entire trailing edge of either only the forward leading edge slat or of only the trailing leading edge slat and in certain useful embodiments at least 4%, at least 7%, at least 15% and much more even exceeding 87% of each such leading edge slat's respective chord length so projects above such tangent plane of the main deflector. In particular, as shall be described further herein, in certain embodiments it is most important that at least the entire trailing edge of the trailing leading edge slat, and in certain useful embodiments at least 4%, at least 7%, at least 15% and much more even exceeding 87% of its chord length projects above such tangent plane of the main deflector, while in other embodiments it is important that the entire trailing edge of the forward leading edge slat, and in certain useful embodiments at least 4%, at least 7%, at least 15% and much more even exceeding 87% of its chord length projects above such tangent plane of the main deflector. The forward leading edge slat preferably includes a portion of itself the lies above such tangent plane. When the there are at least two leading edge slats, i.e. the forward and trailing leading edge slats shown herein, then their entire trailing edges, and in certain useful embodiments at least 4%, at least 7%, at least 15% and much more even exceeding 87% of the chord lengths of such leading edge slats preferably project different distances above such tangent plane, or one such leading edge slat's entire trailing edge projects above such tangent plane while another such leading edge slats entire trailing edge does not project above such tangent plane, as experimentally determined suitable for a particular main deflector's profile. One ordinarily skilled in the art having read the instant disclosure shall be enabled to know to make such experimentation in order to obtain technical parameters for various main deflector profiles, such parameters intended to be encompassed within the scope of the present disclosure

For example, in some cases the entire trailing edge of that leading edge slat whose leading edge is also the leading edge of the trawl door, and preferably as well at least 2% of its chord length preferably projects less far above such tangent plane than does the trailing edge of another leading edge slat, such as of the trailing leading edge slat. However, when the chord length of the trailing leading edge slat is much less than that of the forward leading edge slat, and in particular is at least 33% less, then the entire trailing edge of the forward leading edge slat may project above the trailing edge of the trailing leading edge slat, and preferably also above such tangent plane.

It is most preferable that the trawl door of the present disclosure having the features shown and described in reference to FIG. 3 has the taught dihedral construction for improved efficiency during actual trawling operations.

In continuing reference to FIG. 3, it is especially important that the angles of inclination of the leading edge slats differ from one another. In particular, it is especially important that the angle of inclination of the forward leading edge slat is greater than the angle of inclination of another leading edge slat used with the trawl door of the present disclosure, e.g. the trailing leading edge slat. Leading edge slats of the present disclosure have their leading edges disposed forward of the main deflector's leading edge, and leading edge slats of the present disclosure have a shorter chord direction line than the main deflector's chord direction line, for example the chord direction line of leading edge slats of the present disclosure preferably are from 30% of to 80% of the length of the chord direction line of a main deflector for a trawl door of the present disclosure and especially preferably are more than 12% shorter, and preferably at least 15% shorter, and preferably again at least 22% shorter, and preferably again at least 30% shorter than the length of the chord direction line of the main deflector with certain embodiments showing at least 50% shorter, at least 55% shorter, at least 60% shorter, and at least 65% shorter.

The angle of inclination of the forward leading edge slat is defined by angle 287 made by the convergence and/or divergence of that imaginary straight line joining leading and trailing edges of the main deflector with another imaginary straight line 81 joining leading and trailing edges of the forward leading edge slat. Similarly, the angle of inclination of the another and especially of the trailing leading edge slat is defined by angle 288 made by the convergence and/or divergence of that imaginary straight line joining leading and trailing edges of the main deflector with another imaginary straight line 82 joining leading and trailing edges of the trailing leading edge slat.

The angle of inclination for any leading edge slat of any the trawl door of the present disclosure, whether one, two, three of more leading edge slats are used, is an angle formed by the convergence and/or divergence of that imaginary straight line joining leading and trailing edges of the main deflector with another imaginary straight line joining leading and trailing edges of any leading edge slat used in forming the trawl door of the present disclosure.

Ideally, there are at least two leading edge slats, and the angles of inclination differ for each of the at least two leading edge slats. However, in certain embodiments, such as when the concavity of the leading slats differs, and especially when the concavity of a forward leading edge slat is greater than a concavity of another leading edge slat, the angles of inclination may be similar (the term “similar” as used herein including same). In such embodiments, as well as in other embodiments of the trawl door of the present disclosure, a forward perforated slat 52 preferably is situated adjacent to and removed from the outer side surface 57 of the forward leading edge slat, and possibly is similarly situated above the another leading edge slat and/or slats.

Though not shown, the forward perforated slat is constructed of extremely hard steel, in order to minimize abrasion during catastrophic events. Preferably, when fabricating either the forward perforated slat or perforated slat 54 from a plate of steel or other metal, a preferred fabrication method includes first forming the perforations in a plate of steel and subsequently rolling it into a desired shape. That is, the cutting by torch of the plate of steel or other metal so as to form the perforations is made prior to rolling the plate of steel or other metal into a desired shape, i.e. into a desired camber. In order to form the forward perforated slat, a plate of steel preferably first has the perforations formed into it, then it is rolled into a desired camber, and then it subsequently is cut into strips, each of which form a portion of the forward perforated slat, such as an upper and a lower portion. Forward perforated slat portions for several trawl doors thus may be formed at one time.

Furthermore, to protect the forward perforated slat from damage a raised fin, a raised bead weld and/or a raised round bar of steel is welded to its shorter and/or lateral sides, or a raised fin with a round bar of steel on its outside edge is useful. That is, preferably not on its leading or trailing edges, though possibly but not ideally on such leading and trailing edges, so as to provide a wear buffering rail of steel formed to function as sleds should the trawl door fall over and be dragged on its back side, and in such a fashion that does not impeded water flow over, along and about the body of the forward perforated slat (i.e. the wear buffering rail is lacking from the leading and trailing edges of the forward perforated slat). The perforated slat itself may also have such wear buffering fins and/or rails in corresponding locations.

To further protect from wear and collision induced damage, the forward perforated slat as well as the perforated slat are affixed at their lateral sides to the trawl doors upper and lower end plates. Preferably, several raised fins extend from the outer side surface of the portion of the trawl door above which is situated either or both the forward perforated slat and the perforated slat, and the forward perforated slat as well as the perforated slat are welded to such raised fins on their undersides, and in some cases are formed as several liner sections and then welded to such raised finds on both their undersides as well as the lateral sides of such sections. The sectioning of the forward perforated slat and of the perforated slat permits easy replacement of a damaged portion, and also prevents any particular impact event from destroying the majority of, for example, the forward perforated slat.

Further ideally, there are at least two leading edge slats, and when the aspect ratio of the trawl door exceeds 2:1 (two to one) the angles of inclination differ for each of the at least two leading edge slats, and the angle of inclination of the forward leading edge slat (i.e that leading edge slat whose leading edge also forms the leading edge of the trawl door) is greater than an angle of inclination of another leading edge slat, i.e. is greater than the angle of inclination of the trailing leading edge slat. This feature can also be useful when the aspect ratio is from 0.5:1 to 3.9:1, as experimentally determined useful. These characteristics, when combined with a dihedral shaped trawl door of the present disclosure best provide for a trawl door most efficacious during actual trawling operations and able to be operated in a wide range of water depths.

However, in some cases, and especially when the aspect ratio is lesser than 2:1, ideally, there are at least two leading edge slats, and the angles of inclination may be similar (including the same) or within three to four degrees of one another for each of the at least two leading edge slats. This feature is especially useful when the aspect ratio is less than 2:1 (two to one), less than 1.5:1 (one point five to one), less than 1.25:1 (one point twenty-five to one); less than 1:1 (one to one), less than 0.75:1 (zero point seventy-five to one); less than 0.6:1 (zero point six to one) and lesser. In such cases, it is important that at least a portion of at least one of the leading edge slats has a profile that:

a) is formed either from an arc of a circle (or from some other bent sheet shape, such as from an arcuate shape) having a radius that is half (50%) or about half of the radius forming an arc of a circle forming at least a portion of the profile of the main deflector body and/or another leading edge slat and especially a trailing leading edge slat; or

b) that is concave in shape, and having a greater camber (including but not limited to having a greater concavity) than the camber of another leading edge slat's profile, and especially having a greater camber for the outer side surface of such slat relative to the camber of the outer side surface of the main deflector body, as may be accomplished in one instance by forming a slat having a profile that is an arc of a circle having a lesser radius than a radius of an arc of a circle forming the profile of either or both another slat such as a trailing leading edge slat, and a main deflector body.

A profile having a greater camber shall include that if a profile of a leading edge slat and/or a main deflector is not formed of an arc of a circle, but rather is formed of a series of connected flat sides, or of any other non-circular concave shape, including a non-airfoil shaped profile concave shape such as slat having a profile formed from a portion of a quasi-circular shape. For the purposes of the present disclosure, a profile's “concavity” shall mean: a distance exhibited along a length of a first straight line intersecting a chord direction line of a certain concave profile at a midpoint between such concave profile's leading and trailing edges, where such first line is normal to the chord direction line of the concave profile and the length of such first line is measured from the point of such first line's intersection with the chord direction line to such intersecting lines contact with the inner side (concave) surface of the concave profile; or, should such concave profile be perforated, where such intersecting line reaches a point in space along another imaginary straight line joining the shortest distance between nearest solid portions of such concave profile. The greater is a ratio obtained by dividing the length of such first line by the length of that chord direction line intersected by such first line, the greater is the concavity of a certain slat and/or main deflector's profile.

In a particularly preferred embodiment, the forward leading edge slat has a profile that is formed from an arc of a circle and/or mainly formed from an arc of a circle where such arc of a circle has a radius that is half (50%) of a radius forming an arc of a circle forming the profile of the main deflector, and/or mainly forming the profile of the main deflector, or is from 45% to 65%, or from 40% to 70%, and at least 33%.

In certain embodiments, a forward leading edge slat may be formed of an arc of a circle having a radius that is about 20% to 25%, or from 20% to 33% that of the arc of a circle from which is formed a main deflectors profile. In such embodiment, such forward leading edge slat is located rather high above line 88, so that its entire trailing edge, and in certain useful embodiments at least 4%, at least 7%, at least 15% and much more even exceeding 87% of its chord length is able to project above a tangent plane of the outer side surface of the main deflector where such tangent plane is parallel to the main deflector's chord direction line. In other embodiments, such forward leading edge slat's entire trailing edge may not project so high above line 88, but at least shall be at a same level above such line 88 as is the trailing edge of a trailing leading edge slat, and may preferably project above such trailing edge of such trailing leading edge slat.

Further, in such particularly preferred embodiment, a trailing leading edge slat exists having a profile formed from an arc of a circle having a radius that is similar (including same) as that radius forming the arc of a circle from which is formed the main deflector's profile.

In a particularly preferred embodiment of the present disclosure, any aspect ratio trawl door of the present disclosure has two leading edge slats, where a forward leading edge slat has a profile that is formed from an arc of a circle having a radius that is half (50%) of a radius forming an arc of a circle forming the profile of the main deflector. In other embodiments, this percentage may be from 45% to 65%, or even from 40% to 60% from 15% to 90%, from 20% to 80%, from 25% to 75%, or from 30% to 75%).

For trawl doors of the present disclosure having aspect ratios exceeding 2:1 (two to one) and leading edge slats formed of bent plates (that includes but is not limited to arcs of circles), ideally the angle of inclination of the forward leading edge slat preferably is at least 30 degrees, also preferably at least 31 degrees, more preferably at least 32 degrees, and ideally at least 33 degrees, at least 34 degrees and can be from 28 degrees to 34 degrees, and in certain embodiments greater. Also ideally, the angle of another leading edge slat, i.e. the trailing leading edge slat especially when there are only two leading edge slats, is at least 28 degrees, more preferably at least 29 degrees, and ideally 30 degrees, and can be from 27 degrees to 31 degrees, and from 26 degrees to 34 degrees and also greater. These angles are especially useful in combination with all the other characteristics described above and below in relation to the portions and features of the profile shown in FIG. 3 for a trawl door of the present disclosure as described herein.

In another embodiment of the present disclosure it is particularly useful to make the forward leading edge slat's profile with a greater concavity, such as from an arc of a circle having a lesser radius than an arc of a circle forming either or both a main deflector's profile or another leading edge slat's profile (such as a trailing leading edge slat's profile) in the ratios and fashion as taught herein when either or both:

a) the aspect ratio of the trawl door of the present disclosure exceeds 2:1 (two to one); and especially when it exceeds 2.2:1 (two point two to one); exceeds 2.3:1 (two point three to one); 2.4:1 (two point four to one); 2.5:1 (two point five to one); 2.6:1 (two point six to one); and 2.7:1 (two point seven to one); and

b) the angle of inclination of at least one leading edge slat, and especially of at least the forward leading edge slat is lesser than 45 degrees, especially lesser than 40 degrees, and especially lesser than 37 degrees, lesser than 36 degrees, lesser than 35 degrees and lesser than 34 degrees, or

i) the aspect ratio is lesser than 2:1 (two to one), lesser than 1.8:1 (one point eight to one), lesser than 1.7:1, lesser than 1.5:1, lesser than 1.3:1, lesser than 1.2:1, lesser than 1.1:1, lesser than 1:1, lesser than 0.8:1, lesser than 0.7:1 and lesser than 0.6:1; and

ii) the angle of inclination of at least one leading edge slat, and especially of at least a forward leading edge slat is lesser than 36 degrees, lesser than 34 degrees, lesser than 32 degrees, lesser than 31 degrees, lesser than 30 degrees, lesser than 29 degrees, lesser than 28 degrees, lesser than 27 degrees, lesser than 26 degrees, lesser than 25 degrees and lesser than twenty-four degrees.

Furthermore, to further increase stability, and in certain embodiments to increase efficiency, a forward perforated slat 52 is situated above and removed from the outer surface of at least one of the leading edge slats, and possible any and all of the leading edge slats, the trawl door of the present disclosure able to have several leading edge slats.

In a presently preferred embodiment a forward perforated slat 52 is situated above and removed from the outer surface of the forward leading edge slat when there are two leading edge slats, as shown in FIG. 3. The total area of perforations in the forward perforated slat, as well as in the perforated slat 54, is at least 12% of the area of the perforated slat and/or the forward perforated slat, more preferably at least 18% and yet more preferably at least 20% of such area. Besides these characteristics, and its location, and its width relative to its height, and the fact that in certain instances it advantageously has its leading edge 153 closer to the forward leading edge slat's leading edge than to the forward leading edge slat's trailing edge, the construction and characteristics of the forward perforated slat are otherwise the same as taught for the perforated slat in the known art as referenced in published PCT application entitled “Perforated Slat Trawl Door”, that hereby is incorporated by reference and/or referred to as though fully set forth here. A trawl door having the forward perforated slat in the position as shown is highly advantageous and very efficient, i.e. even without the perforated slat 54. That position, as shown, includes that the forward perforated slat's leading edge is situated closer to the trailing edge of the leading edge slat above which the forward perforated slat is situated (in this case that leading edge slat being the forward leading edge slat).

However, to increase stability, a trawl door of the present disclosure having both a forward perforated slat disposed removed from and adjacent to the outer side surface of at least one of the trawl door's leading edge slats and preferably disposed adjacent to and above a forward leading edge slat's outer side surface as shown in FIG. 3 and FIG. 7 also includes the perforated slat 54 disposed adjacent to and removed from the outer side surface of the main deflector and having its trailing edge more proximal the trailing edge of the main deflector than its leading edge is proximal the main deflector's leading edge also as shown in FIG. 3 and FIG. 7, as well as other features of the present disclosure as described herein and especially in reference to FIG. 3, is considered a highly useful and versatile embodiment of the present disclosure. In such embodiments, it is especially useful that the leading edge slat above which is disposed the forward leading edge slat have a profile including in at least a portion of the profile an arc of a circle and/or a portion of a bent plate, and especially a profile formed of an arc of a circle or mainly formed of an are of a circle, where the portion of the leading edge slat's profile formed of an arc of a circle has a radius that is both lesser than the radius of an arc of a circle forming and/or mainly forming the main deflector's profile, as well as lesser than a radius of an arc of a circle forming and/or mainly forming another leading slat's profile especially when such another leading edge slat is a trailing leading edge slat. The range of percentage differences between the arc of a circle included in the forward leading edge slat relative to the arc of a circle included in the main deflector's profile as taught supra applies in this embodiment.

When such a trawl door of the present disclosure has a relatively low aspect ratio, such as lesser than 1.5:1, lesser than 1.1, lesser than 0.75:1 and lesser than 0.6:1, it is preferably that there be two or at least two leading edge slats, having similar (including same) angles of inclination, where such angles of inclination are approximately twenty-three degrees and from twenty degrees to twenty-five degrees. Should one leading edge slat have a greater angle of inclination, such preferably is the forward leading edge slat, as taught herein. When the forward perforated slat is disposed above and adjacent to the outer side surface of the forward leading edge slat in such embodiment, the forward perforated slats leading edge is positioned such that it is nearer to the forward leading edge slat's trailing edge than to its leading edge, while the trailing edge of the forward perforated slat can be at a location directly above the forward leading edge slat's trailing edge, or further aft of or slightly forward of such forward leading edge slat's trailing edge, as is experimentally determined suitable for any particular trawl door of the present disclosure.

Ideally, in such as well as in other embodiments of the trawl door of the present disclosure, the thickness of the profile of the main deflector, and especially of that portion of the main deflector formed of an arc of a circle or mainly formed of an arc of a circle, or formed of a bent line (including a bent plate shape and/or a bent sheet shape) or otherwise lacking an airfoil profile, is greater than the thickness of the profile of the leading edge slats, and especially of the forward leading edge slat.

For example, in reference to FIG. 4, both leading edge slats as well as the main deflector have their profiles formed of arcs of circles (and/or formed of a bent line such as a bent steel plate), that radius of an arc of a circle forming the forward leading edge slat is 50% that or about 50% that of a radius of the arc of a circle forming the main deflector (in other word, the camber of the forward leading edge slat is greater than the camber of the main deflector, and in this case also is greater than the camber of the trailing leading edge slat, a greater camber formed by a lesser radius when the shape is an arc of a circle), the trawl door has an aspect ratio of about 0.56:1 or 0.6:1, the forward perforated slat is used as shown. For maximal efficiency the forward perforated slat is used without the perforated slat. However, for a best combination of efficiency and maximal stability the forward perforated slat is used in conjunction with the perforated slat as shown. Furthermore, to maximize efficiency, the thickness of the profile of the main deflector is from 1.25 times to 25 times the thickness of the forward leading edge slat's profile, and ideally from 2 times to ten times, and more ideally about 4 times (including 4 times) the thickness of the forward leading edge slat's profile. The trailing leading edge slat may also have a thicker profile than the forward leading edge slat in such ratios. Though more rarely useful, in certain embodiments the forward leading edge slat may have a thicker profile than a trailing leading edge slat, as can be experimentally determined. The thickness of a profile of any slat and/or main deflector of a trawl door of the present disclosure is measured along a shortest distance between the inner side surface and the outer side surface at any region along the majority of the profile of any slat and/or main deflector of the present disclosure not necessarily including terminal leading and trailing edge, and is for example of a thickness of a main deflector indicated by the shortest distance between arrow head points W-W in FIG. 4 and FIG. 5 and is shown on only the main deflector of FIG. 4 and FIG. 5 for illustrative purposes so as not to clutter the drawings of the present disclosure. Such teachings are contrary to the present state of the art and contrary to the trend in the industry.

In order to increase the efficiency of any trawl door, even without use of either perforated slat 54 or the forward perforated slat, the thickness of the profile of the main deflector is from 1.5 times to ten times the thickness of the forward leading edge slat's profile, and can be from 1.5 times to twelve times or from 1.5 times to 25 times the thickness of the forward leading edge slat's profile and ideally about 4 times (including 4 times) the thickness of the forward leading edge slat's profile. The trailing leading edge slat may also have a thicker profile than the forward leading edge slat in such ratios, and in certain embodiments the forward leading edge slat may have a thicker profile than a trailing leading edge slat, as can be experimentally determined. This is especially important when the main deflector and a leading edge slat have a profile that is formed of, or that mainly is formed of an arc of a circle and/or bent line (such as from a bent steel plate.

Because greater thicknesses between differing foils on a trawl door naturally occur for airfoil shaped profiles, but to the contrary similar thickness naturally occur for profiles formed of arcs of circles or mainly formed of arcs of circles, or otherwise formed from bent plates, such as bent steel plates, thus such embodiment is further contrary to the state of the art and trend in the industry for use in profiles for main deflectors and leading edge slats formed of arcs of circles or mainly formed from arcs of circles) or other bent plate and/or bent line shaped profiles.

In a particular embodiment of such a trawl door of the present disclosure, the trawl door has:

a dihedral shape;

at least two leading edge slats;

a main deflector having profile having a longer chord direction line than a chord direction line of a profile of either of the leading edge slats';

the main deflector and a forward leading edge slat having different thicknesses, and the forward leading edge slat and the another leading edge slat having different thicknesses;

the forward leading edge slat having a profile formed of an arc of a circle having a radius smaller than, and specifically about 50% of a radius forming an arc of a circle forming a profile of the main deflector and also of the another leading edge slat;

a profile of a portion of the trawl door including a ratio of the main deflector's profiles thickness relative to the another leading edge slat's profile thickness and relative to the forward leading edge slat's profile thickness of:

a) 17:19:23, respectively, at shallow angles of attack, e.g. ten to 25 degrees;

b)33:19:23 respectively, at medium angles of attack; and

c) 25:19:23, respectively, at high angles of attack.

Thus, it can be seen that the thickness of the profile of the main deflector can be from 1.4 times thicker to 30% lesser than the thickness of the profile of a forward leading edge slat, and from 1.75 times thicker to 20% lesser than the thickness of the profile of a trailing leading edge slat (i.e. another leading edge slat).

However, in presently preferred embodiments, when the forward perforated slat is properly used in conjunction with the perforated slat 54 as taught herein, the ratio of the thickness of the profile of the main deflector relative to the profile of either the forward or trailing leading edge slats can be quite different, as taught herein. For example, to maximize efficiency, the thickness of the profile of the main deflector is from 1.25 times to 25 times the thickness of the forward leading edge slat's profile, and ideally from 2 times to ten times, and more ideally about 4 times (including 4 times) the thickness of the forward leading edge slat's profile. The trailing leading edge slat may also have a thicker profile than the forward leading edge slat in such ratios, and in certain embodiments the forward leading edge slat may have a thicker profile than a trailing leading edge slat, as can be experimentally determined.

The profile of any of the foils of the trawl door of the present disclosure (the term “foil” including any of a leading edge slat or a main deflector), when formed of the varying thickness embodiment for the profiles of these foils of the trawl door, most preferably have a uniform thickness throughout most of the length of foil's profile (i.e. the majority of the profile has a uniform thickness, or a thickness that generally is uniform, and especially that for the majority of the profile is within 7% of being the same, and within 6%, within 5%, within 4%, within 3%, within 2% and within 1% of being the same (see FIG. 4 and FIG. 5). However, though less desirable, they also may have a profile having a varying thickness throughout a foil's length. An example of a foil having a profile exhibiting a varying thickness is shown in FIG. 6, where the thickness of the profile is maximal at a point that is about equidistant between the leading and trailing edge of the main deflector. In this embodiment, the width of the profile shall be measured at its thickest point for purposes of the instant disclosures teachings. The profile of any perforated slat of the present disclosure may also be formed in similar fashion as that shown and otherwise taught herein for the foils of the leading edge slats and main deflector of trawl doors of the present disclosure.

Such thicker profiles for foils of trawl doors of the present disclosure may be formed by firstly forming a foil such as a main deflector from a bent steel plate, and secondly attaching to such bent steel plate a similarly shaped body of for example a synthetic substance, so as to arrive at the desired profile. However, due to the fact that strengthening portions are often present in trawl doors known as “ribs” or “bananas” (see reference numeral 933 in FIG. 1), several bodies of a synthetic or natural substance may be designed and configured to fit within and in between such “ribs” and/or “bananas”, as well as to fit in and between other strengthening parts of a trawl door of present disclosure, so as to provide the desired profile. For example, a foil for a trawl door of the present disclosure may be formed of a bent steel plate that has a smooth outer side surface, that has several bananas and/or ribs on its inner side surface, and that has several portions designed, configured and adapted to be inserted in between such bananas and/or ribs and affixed to the bent steel plate's inner side surface by gluing, bolting, clamping on the like. The end result is that the primary lift generating portion of the trawl door has the desired profile. Nyrim® is considered a suitable synthetic substance for forming such portions of the trawl door. To repair such trawl door, individual damaged portions of the synthetic substance may be removed and replaced. Alternatively, the profiles of trawl door foils of the present disclosure may be formed of double walled steel plates, preferably filled with a closed cell foam.

In embodiments of trawl doors of the present disclosure where either a forward leading edge slat and/or a main deflector is formed from with a profile that is an arc of a circle, or that mainly is formed from an arc of a circle, or that is formed of a bent line such as a bent plate, it is preferred that a distance from the leading edge of the trawl door to the leading edge of the main deflector be from 28% to 44% the distance from the leading edge of the trawl door to the trailing edge of the main deflector. Preferably, this distance is from 30% to 40%, more preferably from 33% to 38%, and yet more preferably from 33.5% to 37.5%.

In reference to FIG. 7, shown is a preferred embodiment of a trawl door of the present disclosure for shallow angles of attack, e.g. 3 degrees to 25 degrees, and especially 5 degrees to twenty degrees, and more especially 5 degrees to 15 degrees, such as useful in surface fishing with synthetic warps and or in seismic applications. Shown is a main deflector formed of an airfoil profile as well as a single leading edge slat, in this case a forward leading edge slat, also formed of an airfoil profile. In the instant preferred embodiment, the trawl door's profile consists essentially of the shown forward leading edge slat as well as of the shown main deflector. However, it is highly important that a forward perforated slat be positioned removed from and adjacent to the outer side surface of the forward perforated slat, either as shown, or with approximately half the length of the forward perforated slat located above the outer side surface of the forward leading edge slat and with approximately half the length of the forward perforated slat protruding beyond the trailing edge of the forward leading edge slat, the leading edge of the forward perforated slat in such embodiment of the present disclosure located aft of the leading edge of the forward leading edge slat, and approximately midpoint between the leading and trailing edges of the forward leading edge slat.

The camber of the forward perforated slat in such embodiment may correspond, or be similar to the camber of the outer side surface of the forward leading edge slat. Or it may be formed from an arc of a circle having a diameter same as or similar to the distance from the leading edge of the trawl door to the trailing edge of the trawl door, or within from at least 50%, to at least 60% to from 66% to 95% of such distance.

In continued reference to FIG. 7: Both the forward leading edge slat as well as the main deflector have the same profile. It presently is preferred to use that profile having its profile known by the name and/or code “NACA-338117” as found in a software programme known as “VisualFoil Version 4.1”, such software program sold by Hanley Innovations/Dr. P. Hanley, Ocala, Fla.)”. The maximally efficient low-speed high-lift airfoil profile software program is hereby incorporated by reference.
While the above referenced airfoil profile is highly useful, other airfoil profiles characterized by the fact that the profile has:
a) a thickest segment that is between thirteen percent (13%) and twenty-four percent (24%) of a chord of the profile; and preferably between 16% and 21%, and preferably between 17% and 19%, an yet more preferably between 17% and 18%, and;
b) where the thickest segment is situated front of center in the profile (i.e. more proximal the profile's leading edge than it is proximal the profile's trailing edge); and
c) a concave inner side and a convex outer side having a thickness therebetween which becomes:
   i) progressively narrower between the thickest segment of the profile and a leading edge of the profile; and
   ii) progressively narrower between the thickest segment of the profile and a trailing edge of the profile,
is highly useful in this embodiment of trawl doors of the present disclosure, whereby lift generated by the trawl door is improved, especially at shallow angles of attack as used in seismic and other applications.
The use of such embodiment of a trawl door of the present disclosure to tow upon and/or influence the position of any portion of a towed seismic array, such as a streamer, super-wide (paravane line), or the like, and the production of data useful in determining the location of solid, liquid and/or gaseous energy reserves, and the method of using such trawl door of the present disclosure is a highly useful embodiment of the instant present disclosure.

In such embodiment of trawl doors of the present disclosure as shown and taught supra and herein in reference to FIG. 7, it is highly useful that the trawl door's profile consists essentially of a forward leading edge slat and a main deflector having the “NACA-338117” profile mentioned herein as well as varying embodiments of other airfoil profiles as taught herein; including where the profile of the forward leading edge slat as well as the profile of the main deflector both are formed of the same profile such as when both are formed of such “NACA-338117” profile. Furthermore, a forward perforated slat in the position as shown adjacent to and removed from the outer side surface of the forward leading edge slat and constructed and configured as taught herein, is highly useful for maximizing efficiency of trawl doors of the present disclosure formed as taught in reference to FIG. 7. Furthermore, a perforated slat 54 in the position as shown adjacent to and removed from the outer side surface of the main deflector and constructed and configured as taught herein, is highly useful for maximizing stability and thus allowing utilization of maximal efficiency of such embodiment of a trawl door of the present disclosure.

Nonetheless, in certain embodiment a trailing leading edge slat may be used with such profile for such trawl door of the present disclosure as shown in FIG. 7, where such trailing leading edge slat may be formed either of the same airfoil profile as forms the forward leading edge slat, but in a smaller scale. Or, such trailing leading edge slat may be formed of a bent plate, including of an arc of a circle, and may have its trailing edge positioned between the trailing edge of the forward leading edge slat and the line 88, especially for seismic applications and low angle of attack/high speed trawling applications. For other applications, such trailing leading edge slat may have its entire trailing edge and in certain useful embodiments at least 4%, at least 7%, at least 15% and much more even exceeding 87% of it chord length projecting above a tangent plane of the outer side surface of the main deflector body where such tangent plane is parallel to the chord direction line of the main deflector body.

By “consists essentially of” it shall mean that the addition of other constructional features not able to increase the efficiency of the trawl door by more than 15%, and/or not taught herein is not intended to create a trawl door that would not be encompassed by any claims obtainable from the teachings of this embodiment of the present disclosure.

Such embodiment of a trawl door of the present disclosure also usefully has trailing slats 47a located near the trailing edge of the main deflector and removed some distance from the inner side surface (concave side surface) of the main deflector, as shown, that may be straight lines, as shown, or may have a camber similar to the camber of the inner side surface of the main deflector nearest to such slats. Very usefully, the leading edge slat has a forward perforated slat situated relative to the forward leading edge slat's outer side surface as shown in the drawing of FIG. 7 and as taught herein.

In reference to FIG. 7, embodiments of trawl doors of the present disclosure as taught herein where a leading edge slat and especially where the forward leading edge slat, and also where a main deflector is formed from with a profile that is an airfoil profile, especially the “NACA-338117” profile, it is preferred that a distance from the leading edge of the trawl door to the leading edge of the main deflector be from 21% to 34% the distance from the leading edge of the trawl door to the trailing edge of the main deflector. Preferably, this distance is from 22% to 33%, more preferably from 24% to 30%, yet more preferably from 25% to 29%, and yet more preferably from 26% to 28%, with about 26% and about 27% being highly useful, depending upon exactly what is considered to be the leading edge of the trawl door.

In further reference to FIG. 7, it is highly important that the leading edge of the forward leading edge slat be situated a height above an axis of the imaginary line connecting leading and trailing edges of the main deflector, especially a height that is from 6% to 27% of the length from the leading edge to the trailing edge of the main deflector, and especially from 8% to 20%, and especially from 10% to 18%, and especially from 12% to 16%, with from 13% to 14% being preferred, and with about 12%, about 13%, and about 14% being highly useful, and at least 5% being useful.

The entire trailing edge of the forward leading edge slat and in certain useful embodiments at least 4%, at least 7%, at least 15% and much more even exceeding 87% of it chord length preferably projects above a tangent plane of the outer side surface of the main deflector where such tangent plane is parallel to the chord direction line of the main deflector. Preferably, such trailing edge of such forward leading edge slat is situated a distance above the outer side surface of the main deflector a distance that is at least 4% the length of the chord direction line of the main deflector, more preferably at least 8%, more preferably at least 10%, with about 13.4% being preferred, with from 11% to 21% being useful, and from 11% to 46% being applicable as experimentally determined useful.

In continued reference to FIG. 7, the angle of inclination of the forward leading edge slat is usefully from 23 degrees to 34 degrees, with about 28 degrees (including 28 degrees) being presently preferred, with from 26 degrees to 31 degrees being useful, with from 26 degrees to 30 degrees being more useful.

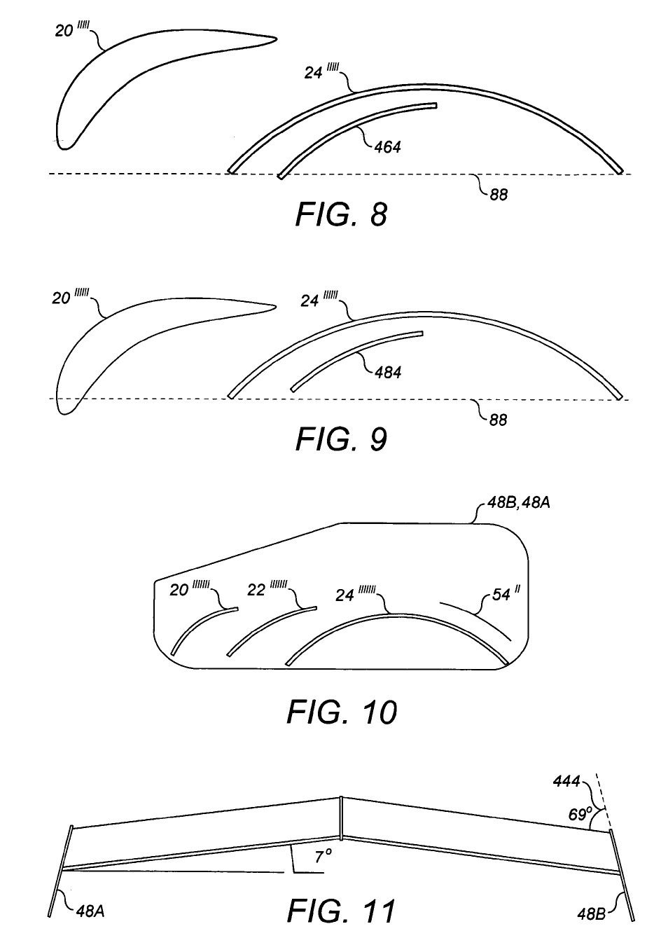

In further continuing reference to FIG. 7, and in particular reference to FIGS. 8 and 22y: in an alternate embodiment of the present disclosure, a trawl door is formed that is highly useful at a wide range of angles of attack, including at ranges including from 5 degrees to 50 degrees, and from 25 degrees to 45 degrees, by forming the main deflector body with a profile that is an arc of a circle, or that otherwise is formed of a bent plate (including a bent line), including having a substantial thickness as described supra, while simultaneously forming a forward leading edge slat of an airfoil profile, where the maximal thickness of the forward leading edge slat's profile exceeds the maximal thickness of the main deflector's profile. Preferably, in such embodiments the chord direction line has a lesser length for the forward leading slat than for the main deflector body, however, in certain embodiments this may be reversed. Thus for example, the main deflector body is formed of an arc of a circle as shown for the main deflector bodies of those embodiments of the disclosed trawl door taught in reference to FIG. 4 and FIG. 5, and the forward leading edge slat is formed with an airfoil profile as shown in FIG. 7 and as otherwise taught herein. FIG. 7 shows an embodiment most useful for angles of attack greater than twenty degrees, and FIG. 9 shows an embodiment most useful for angles of attack lesser than twenty degrees. However, both the profiles shown in FIG. 8 and in FIG. 9 are useful at a wide range of angles of attack, i.e. both are useful at lesser than or greater than twenty degrees angles of attack. Otherwise the trawl door is formed as taught herein in reference to FIG. 7 and as otherwise taught herein.

In further reference to FIG. 8 and FIG. 9: reference numerals 464 and 484 indicate various embodiments of a internal main deflector slat. In one embodiment, the leading edge of the internal main deflector slat is outside the chord direction line of the main deflector body, and in another it is inside the chord direction line of the main deflector body. A distance between the inside concave surface of the main deflector body and the outer convex surface of the internal main deflector slat is greater in a region proximal the internal deflector body slat's leading edge than it is in a region more proximal the internal deflector body slat's trailing edge.

In another embodiment of the present disclosure that is useful with all other embodiments of the present disclosure: the end plates of the trawl door, especially upper and lower end plates, are preferably formed with a greater amount of surface area than is presently the state of the art and the trend in the industry, especially for angles of attack of lesser than 37 degrees. The term “end plate” shall mean the same as the term “support plate” for the following teachings:

In reference to FIG. 10 and FIG. 11; both the drawings being approximately to scale and any information measurable from such drawings intended to be encompassed by the present disclosure:
FIG. 10 is a bottom plan view of the support plate of a trawl door of the present disclosure with the profile of primary lift generating portions of the trawl door's shown where they attach to such support plate,

Also in reference to FIG. 11, which is a front plan view of a trawl door of the present disclosure using such support plates of FIG. 10:

for such embodiments of the present disclosure:
a) At least one of the foils is a forward leading slat;
   and the most forward leading slat has a portion of a support plate extending both above of as well as below, and with the support plate extending a greater distance below the forward leading slat's chord direction line than it extends below the main deflector's chord direction line, i.e. on both sides of, its convex side surface, where such support plate preferably is connected to the support plate forming a support plate also extending on both sides of a plane contacting the convex side surface of other foils of the trawl doors, especially of:

a main deflector body convex side surface; and

another leading slat that is not a forward leading slat's convex side surface.
b) there is a support plate forming the upper end plate and also forming the lower end plate, and optionally forming the central plate, each such support plate having a surface area that is about 0.173 times the surface area of the foils forming the primary lift generating structure of the trawl door. This ratio can be from 0.1 to 0.25.
c) the support plate has a tapered forward edge. Especially, the portion of the support plate forward of the leading edge of the main deflector body has a lesser area than the portion of the support plate aft of the leading edge of the main deflector body, preferably at least 90 percent lesser, at least 80 percent lesser, at least 70 percent lesser, and can be at least 60 percent lesser.
   Also, a ratio obtained by dividing the support plate area above the forward leading slat and/or forward leading slats by the support plate area below the forward leading slat and/or forward leading slats is lesser than another ratio obtained by dividing the support plate area above the main deflector body by the support plate area below the main deflector body.
D) the support plates have a tilt angle, indicated by reference numeral 444, defined as the angle between:
   i) the leading edge axis of the door portion upon which is mounted the support plate; and
   ii) the support plate plane axis, where such angle is measured/taken on the side of such support plate's plane that is nearest to the center of the door, i.e. nearer to the warp connection point of the door,

where such tilt angle is:
(i) lesser than 90 degrees, is from 61 degrees to eighty-eight degrees, preferably is lesser than 80 degrees and yet more preferably lesser than 70 degrees, and preferably is from 64 degrees to 71 degrees with about 69 (sixty nine) degrees being most preferred. These teachings are especially useful for all angles of attack including angles for use with trawl doors constructed to be fished with angles of attack greater than 19 degrees and even greater than 45 degrees; and
(ii) in certain embodiments can be greater than 90 degrees when for use with trawl doors constructed to be fished with angles of attack lesser than twenty degrees.
   The upper support plate has a thickness that is lesser than the lower support plate's thickness. They may be made entirely or partially of plastic or synthetic material where the trawl door is made of steel, or include synthetic portions, such as formed of Nyrim, and thus include a material dissimilar to a material from which the majority of the trawl doors mainly is formed.

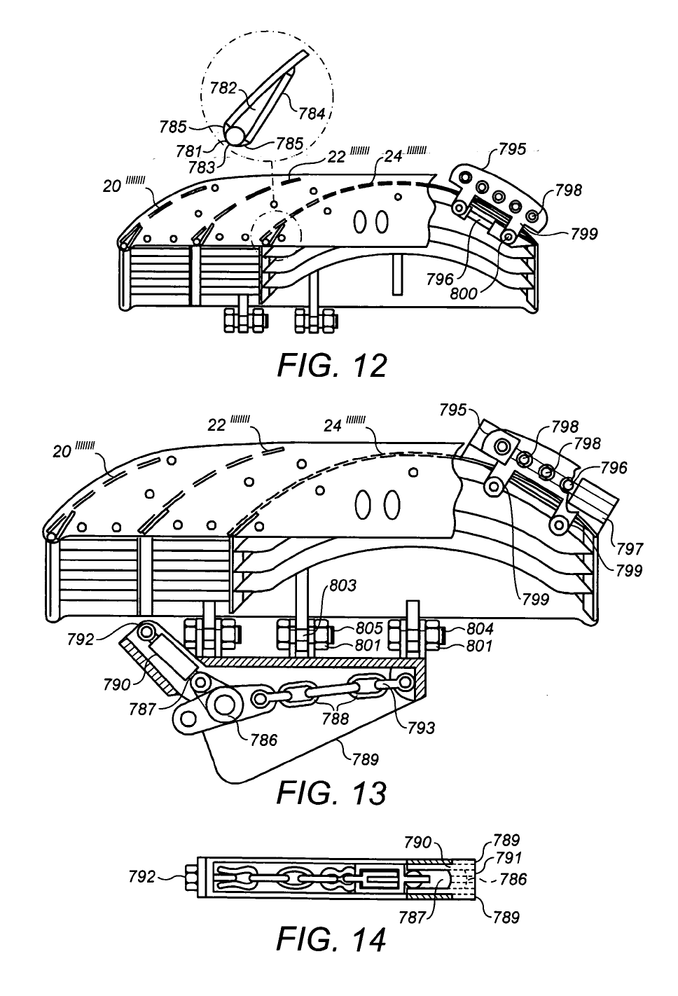

Preferably, the forward leading edge slat and the main deflector are hollow and/or include hollow cavities adapted to receive machinery permitting remotely controlling the angle of attack, tilt and yaw of the trawl door. Where embodiments of the trawl door of the present disclosure include profiles formed of arcs of circles, where the thickness of the profile permits such hollow cavities, such are preferred. However, where the dimensions of such profile preclude such hollow cavities due to strength requirements, it is useful to form such hollow cavities by constructing a hollow structure to strengthen the leading edge of a foil of the trawl door, such as the leading edge of the main deflector's foil. In reference to FIG. 12 (a top plan view of a profile of a trawl door of the present disclosure including a top plan view of a pertinent herein described feature of such disclosed trawl door): shown is foil leading edge re-enforcement structure 781 having hollow linear cavity 782 located vertically along the vertical dimension of the leading edge of the foil. The cavity is formed by round bar 783, plate 784, main deflector 24″″′, and bead welds 785 filling in needed gaps between the round bar, plate and main deflector. The walls of the hollow cavity may be perforated as needed to pass lines including hydraulic lines and other structures.

In reference to FIG. 13 (also a top plan view of a profile of a trawl door of the present disclosure including a top plan view of a pertinent herein described feature of such disclosed trawl door where the top slit forming plate is removed): to remotely (including automatically) control the angle of attack of the trawl door of the present disclosure, the trawl door is provided with attack angle altering apparatus 790 including a moveable connection point 786 for connecting to main towing warp 74 where such moveable connection point is attached both to an attack angle retractable arm 787 (the term “retractable” as used herein shall include “extendable” and vice versa), such as a hydraulic ram, screw jack, worm gear, chain or cable drive or the like and also is attached to an attack angle length of line 788, that may be a length of chain or even a rigid steel rod or rigid steel plate having a moveable (especially pivotal) attachment point to the trawl door at its end distal from the moveable connection point. The attack angle retractable arm has its long dimension lying and/or mainly lying in a plane that is coplanar with a profile of a portion of the primary lift generating portion of the trawl door. Preferably, the attack angle retractable arm is more forward of the both the moveable connection point as well as of the attack angle length of line, and preferably the attack angle length of line is aft both of the moveable connection point as well as of the attack angle retractable arm.

To protect the attack angle retractable arm from damage, the attack angle retractable arm is “sandwiched” between two slit forming plates of steel 789, i.e. upper and lower slit forming plates 789 (see FIG. 14, that is a front plan view of the pertinent portion of the trawl door of the present disclosure).

That is, it is located between two plates of steel designed and configured both to completely enclose the attack angle altering apparatus, except for warp passage slit 791. The warp passage slit allows the trawler's warp (not shown) to affix to the moveable connection point at the full range of motion of the moveable connection point. Otherwise, the upper and lower slit forming plates are joined at their outside edges by portions of steel plate so as to provide maximal strength to the protective shell formed by the slit forming plates.

Preferably, the attack angle retractable arm is pivotally (i.e. hingedly) attached to either the inner side surface of the trawl door and/or to a suitable portion of the attack angle altering apparatus as described herein. For example, if a hinge is used to make such attachment, the hinge is designed and configured so as to permit the attack angle retractable arm to pivot in a fore to aft direction, i.e. from front to back and within the space, gap and plane defined and created by the slit forming plates as taught herein. This prevents damage to the attack angle retractable arm from shocks and other damaging forces traveling through the towing warp and trawl door during trawling operations, and also during other operations, such as seismic operations.

The range of motion of the moveable connection point is determined by the combination of at least (i) the length of the attack angle length of line; (ii) the maximal, minimal and intermediate positions of the attack angle retractable arm; and (iii) the distance between the base 792 of the attack angle retractable arm and the aft fixed point 793 of the attack angle length of line. The moveable connection plate preferably has a bushing or sliding shim that eliminates and/or minimizes void space in the vertical orientation between the moveable connection point and the inside surfaces of the upper and lower slit forming plates, so as to prevent damage to the attack angle retractable arm attached to the moveable connection point. The moveable connection point may be designed and configured so as to protrude from the extremity of the gap formed by the slit forming plates, thereby allowing unobstructed access to the moveably connection point, especially when the attack angle altering apparatus is not hingedly affixed to the remainder of the disclosed trawl door, although such hinged affixation is preferable, as taught below. When such hinged fixing of the attack angle altering apparatus is employed, the moveable connection point is designed and configured so as to permit easy access to the moveable connection point, including having an aperture formed in such moveable connection point that has its hollow cavity accessible from aft and fore ends, as the upper and lower ends may be designed to fit more or less flush with the inside surfaces of the slit forming plates. Or, a length of chain, or shackles, may extend from an embodiment of the moveable connection point that does not protrude without the gap formed by the slit forming plates, and the towing warp may be connected to such chain or shackle.

Optionally and usefully, the portion of an arc of a circle capable of being defined within the slit forming plates by a pivotal movement of the attack angle length of line in a plane co-parallel to the slit moving plates is used to determine the location of a channel that is formed into the inside surfaces of both the upper and lower slit forming plates. Then, the moveable connection point has a male end that is constructed and configured to ride within such channel. Thus, shock forces are transmitted directly to the slit forming plates, thereby minimizing damage to the retractable/extendable arm.

To further preclude damage to the attack angle retractable arm; the slit forming plates preferably are both mounted on a hinged body, such as a super strong hinged pin, where such hinged body connects the slit forming plates and remainder of the attack angle altering apparatus to the remainder of the disclosed trawl door. The hinged body permits the entire attack angel altering apparatus to pivot at its connection to the remainder of the disclosed trawl door in a vertical and/or mainly vertical direction upward and downward relative to the vertical dimension of the trawl door. This also permits maintaining an ideal orientation of the attack angle retractable arm and towing warp at various trawling depths, and also serves to preclude unbalancing forces from tipping the trawl door inward or outward.

Optionally and as experimentally determined useful; the attack angle retractable arm may be loosely connected to the moveable connection point in such a fashion as to protect the attack angle retractable arm from front to aft and/or from mainly front to aft oriented shock forces transmitted through the attack angle length of line, moveable connection point and towing warp. Such loosely constructed connection may include a rubber bushing between the attack angle retractable arm and the moveable connection point, or a coil spring in such position, or a leaf spring in such position, hinge, or male/female end attachment having large void spaces, a large void space ball and socket joint, or the like. Or, the attack angle retractable arm may at its connection to the moveable connection point be constructed and configured so as to have a circular opening encompassing a pin body of the moveable connection point with substantial void space to permit some movements.

In order to control the angle of attack of the trawl door, the attack angle retractable arm is shortened (retracted) in order to reduce the trawl door's angle of attack, and is lengthened (extended) in order to increase the trawl door's angle of attack.

In order to control the pitch of the trawl door, so as to maintain the trawl door's leading edge in as much a perpendicular orientation as possible relative to the oncoming water flow vector and/or relative to the direction of the trawling vessel considering the construction of the trawl door (i.e. depending upon whether the leading edge is “straight” or “swept back”), and/or so as to maintain the trawl door's profile as coplanar as possible with a horizontal plane intersecting the direction of travel of the trawl door and the direction of the oncoming water flow vector, pitch variable backstrop bracket 795 is employed (see FIG. 12 and FIG. 13).

As shown further in FIG. 12 and also in FIG. 13, the pitch variable backstrop bracket includes a retractable (including “extendable”) backstrop arm 796 such as may be formed of a hydraulic ram, screw jack or worm gear having its extendable (including “rectractable) linear portion either or both (i) hingedly and/or rotatably attached to the pitch variable backstrop bracket at moveable joint 800; or (ii) slideably received within a female end support sleeve 797 that is fixedly attached to the trawl door. The retractable backstrop arm either may be located within the structure of the trawl door, especially when the width of the profile allows for inclusion of the retractable backstrop arm within the profile of the trawl door, such as within the profile of the main deflector shown in FIG. 7. However, when the profile of the trawl door does not permit to include the retractable backstrop arm within such profile, it may be positioned on the inner side surface of the trawl door, such as on the inner side surface of the main deflector shown in FIG. 12. Or, it may be located on the outside surface of the trawl door, such as on the outer side surface of the main deflector, as shown in FIG. 13. However, when it is not possible to include such retractable backstrop arm within the profile of the trawl door, it preferably is located on the inner side surface of the trawl door. The pitch variable backstrop bracket has multiple hole options 798, is attached to the retractable backstrop arm at pitch variable backstrop bracket foot 799. The pitch variable backstrop bracket foot also is slideably received through the plate and/or other structure forming the profile of the main deflector, or at least partially through such profile in the case of a bulky profile. A re-enforcing structure 800 (see FIG. 12) may increase the bulk, mass and strength of the main deflector's profile where such pitch variable backstrop bracket foot is slideabley received therein. By advancing toward the leading edge of the trawl door the pitch variable backstrop bracket, such as is accomplished in the instant example by retracting the retractable backstrop arm, the lowest portion of the trawl door's leading edge is advanced forward while the uppermost portion of the trawl door's leading edge is advanced backward, relative to one another. In order to reverse their positions, the pitch variable backstrop bracket is reversed and moved aft, toward the trailing edge of the trawl door, as is accomplished by extending the retractable backstrop arm. Thus, the pitch of the trawl door is controlled. (Should the retractable backstrop arm be located aft of the pitch variable backstrop bracket, these sequences are reversed). The entire structure of the pitch variable backstrop bracket may be included in a streamlined casing, to shield it from damage and reduce its drag. Such casing preferably provides for access to the pitch variable backstrop bracket such as by being removable or having a hinged flap or door, so as to permit maintenance.

Preferably, the pitch variable backstrop bracket is formed only at a location on a trawl door of the present disclosure that is more proximal the trawl doors upper edge than it is proximal the trawl door's lower edge, to preclude damage to the machinery of the pitch variable backstrop bracket. However, one, two, three or all backstop brackets on a trawl door of the present disclosure may employ such pitch variable backstrop bracket, though there only is need for one located near the top of the trawl door.

In order to control the tilt of the trawl door, such as often is desirable in order to accelerate the rate of ascent or descent of a trawl door of the present disclosure and thus of a trawl connected to a trawl door of the present disclosure, a trawl door tilt control apparatus 801 optionally is employed

In reference to FIG. 14 and also to FIG. 15 (FIG. 15 also being a front plan view of the pertinent portion of the disclosed trawl door), the trawl door tilt control apparatus includes a high strength hinge 804 formed of a high strength pin bolt 803 passed through multiple high strength pin bolt receiving sleeves 805. The high strength hinge hingedly connects the attack angle altering apparatus to the trawl door, preferably at the trawl door's inner side surface. The trawl door tilt control apparatus includes at least one, and optionally two or more tilt varying extendable (including “retractable”) arms 806, that are moveably and especially hingedly attached at moveable connections 807 to the outer sides of the slit forming plates. In the instant example the tilt control apparatus includes upper and lower tilt varying extendable arms 806u and 806l. In order to cause the lower portion of the trawl door to move in an outboard direction, while also causing the upper portion of the trawl door to move in an inboard direction, thereby increasing the door's propensity to rise toward the surface, either or both (I) the upper tilt varying extendable arm is retracted (i.e. shortened); and/or (II) the lower tilt varying extendable arm is extended (i.e. lengthened). The trawl door's propensity to dive is increased in reverse order.

In order to protect any tilt varying extendable arm from damage, such tilt varying extendable arm may be contained within a protective sleeve, including a protective sleeve itself having a slideable, retractable and extendable portion. Similarly, the tilt varying. extendable arms may be protected by a series of steel pipes extending in a front to aft orientation and bowed out from the inner side surface of the trawl door so as to form a protective cage or other barrier enclosing the tilt varying extendable arms within and between the cage and the inner side surface of the trawl door.

Alternatively, and most preferably, whenever the dimensions of the trawl door's profile allow, the trawl door tilt control apparatus is contained within and/or at least partially and/or mainly contained within the main deflector body of the trawl door, as indicated by dashed line cutout 809 indicating the outline of the main deflector body shown in FIG. 7.

In such embodiments, additionally provided are any needed openings and/or perforations in the trawl door's main deflector and/or other trawl door portion so as to permit operation of moving parts. For example, a longitudinal slit 810 may extend in a fore to aft direction and be designed and configured so as to permit the warp to reach the moveable connection point throughout the range of motion of the moveable connection point. For another example, one or more vertically oriented slits (not shown) may be provided to permit passage of the tilt varying extendable arms, such as when the slit forming plates are protruding without the profile of the trawl door and/or located external whatever portion of the trawl door they are attached to.

In continuing reference to FIG. 15, alternative to the upper and lower tilt varying extendable arms a motor or motors imparting rotation to the high strength pin bolt may be located at one or both distal ends 808 of such high strength pin bolt. By rotating such distal end, the moveable connection point is moved upward, or downward, as desired. Such motor may be a hydraulic motor, electric motor, or other, geared so as to provide the needed transfer of energy so as to move the moveable connection point upward or downward.

Alternatively both to the rotatable motor located at one or both distal ends of the high strength pin bolt as well as to upper and lower tilt varying extendable arms 806u and 8061, vertically extendable (including retractable) arm 812 may be provided to raise or lower in a vertical direction all parts of the attack angle altering apparatus. Such vertical control extendable arm 812 is affixed to rigid support brackets 814 at both ends, that themselves are fixedly attached to the trawl door and/or including its frame, and connects to the attack angle control apparatus at mounting points 815, that can be welds, bolts or other. The vertical control extendable arm can be a hydraulic ram having ram arm 813, a screw jack, formed of a worm gear or other.

That is, in such embodiment of the present disclosure the attack angle altering apparatus is mounted to a moveable carriage that itself is slideably mounted and received to a portion of the trawl door and/or its frame. One, two or more vertically extendable arms 812 raise and lower such moveable carriage upon which is mounted the attack angle altering apparatus, thus necessarily raising and lowering the moveable connection point relative to the height of the trawl door. In order to increase the climb of the trawl door, the moveable connection point is raised, thereby causing a lower trawl door section to advance relatively further outboard while an upper trawl door section moves relatively further inboard, thereby increasing climbing forces generated by the trawl door. Oppositely and similarly, in order to increase the dive propensity of the trawl door, the moveable connection point is lowered.

In order to minimize required vertical motion of the carriage and/or moveable connection point, and thus minimize construction costs and weight, the disclosed trawl door preferably is attached to trawl net bridles at backstrop brackets located near the upper and lower edges of the trawl door, including brackets not equidistant from the moveable connection point.

Similarly, the pitch variable backstrop bracket and the tilt control apparatus may optionally be mounted upon a moveable carriage that is slideably mounted to the trawl door and/or its frame so as to provide for to aft movement of the pitch variable backstrop bracket and/or tilt control apparatus, respectively, with movement provided by one or more the retractable (including extendable) arms formed of a worm gear, screw jack, hydraulic jack, chain drive, cable drive or the like. Thus, the pitch and attack angle of the trawl door, respectively, are altered. Or, the moveable connection point itself may be mounted upon a moveable carriage that is slideably mounted to the trawl door and/or its frame, with movement similarly provided by similar retractable arms and the like mentioned herein, so as to provide fore to aft movement of the moveable connection point, thereby altering trawl door angle of attack.

The various retractable and/or extendable arms of the trawl door's attack angle altering apparatus, pitch variable backstrop bracket and tilt control apparatus are either controlled remotely or automatically. Remote control can be accomplished by, for example using either wireless transmitters and/or information conductors located within a warp that then connect and communicate a first control unit located at or within the trawl door to a second control unit located aboard the trawling vessel. An onboard control unit aboard the trawler may perform the function of the second control unit. Alternatively, the second control unit may be provided with the trawl door of the present disclosure. For both remote control and automatic control, The first and second control unit can be implemented utilizing programmed general purpose processors, application specific processors, firmware, and discrete components and combinations thereof or using remote signals. Power (energy) is provided either through a remote and especially a battery source situated within and/or on the trawl door or through energy conductors located within either a warp or within the headline, bridles, and backstrops of the trawl. For such warp and such headline, bridles and backstrops a powered synthetic cable designed and configured as taught in published PCT application having publication number WO 2009/142766 A2, is highly useful (i.e. having a pre-heat-stretched strength member and a conductor that was formerly slack and subsequently having been permanently elongated during such pre-heat-stretching of the strength member). By combining Vectran fibers and/or other Aramid fibers with Dyneema fibers and or other UHMWPE fibres prior in forming the jacket layer and prior to heat-stretching such strength member, a stronger strength member is arrived at). In this case, the Vectran or other Aramid fibers are formed in another braided layer that enclosed the jacket layer formed of UHMWPE. The braid angle of the Vectran and/or other Armaid fibers is greater than that used to form the enclosed jacket layer of UHMWPE, and is selected so that after heat stretching the combination of the jacket layer of UHMWPE and the layer of braided Vectran and/or other Aramid fibers enclosing the jacket layer of UHWMPE, that the final combination of both layers are balanced. That is, the UHMWPE layer has undergone permanent elongation, preferably about a supportive shaped core of thermoplastic that also has undergone permanent elongation, and also the layer of Vectran and/or other Aramid (or any fibre less elastic than UHMWPE) also has undergone permanent elongation by means of acquiring a narrower diameter, so that both layers are bearing load together more or less equally, and at least are capable of sharing load prior to the step of permanently elongating the rope formed at least of both layers. Both power as well as information can be delivered, and send back to the trawler (especially information), through such synthetic cable encompassing conductors. Such synthetic cable encompassing conductors can connect to the trawl door by being used as a towing warp and having its conductors pulled out of the towing warp near the warps attachment to the disclosed trawl door, made slack, and connected to the information and energy conductors of the disclosed trawl door using known water tight methods. Also, the strength member is connected to the trawl door using known methods, including splicing an eye into the end of the strength member, while preserving needed slack in the conductors. Or, information and energy may be delivered to the trawl door, and send back to the vessel (especially information), by using such synthetic cable encompassing conductors as a headline sonar cable that also splits and continues as a trawl headline, upper bridles and backstrops, thus reaching the disclosed trawl door, where again the conductors are pulled out and connected to the disclosed trawl doors conductors as mentioned supra, and so is the strength member. Thus it is provided that energy and information are able to be delivering from the trawling vessel through the warp and/or headline sonar, headline, bridle and backstrop located information and energy conductors to the trawl door located various retractable and/or extendable arms of the trawl door's attack angle altering apparatus, pitch variable backstrop bracket and tilt control apparatus. Less preferably, power is provided by means of a turbine generator located on the trawl door.

The various retractable and/or extendable arms of the trawl door's attack angle altering apparatus, pitch variable backstrop bracket and tilt control apparatus may preferably be automatically controlled. In such embodiment, the ideal angle of attack of the trawl door is programmed into the first control unit. Sensors including attack angle sensors, pitch sensors and tilt sensors are in communication with the control unit.

The attack angle sensor constantly and/or periodically sends a signal to the control unit indicating the angle of attack of the trawl door. When the trawl door's angle of attack is greater than as desired, the control unit turns on a “Retract” signal to the extendable arm of the trawl door's attack angle altering apparatus. This may include opening a “Retract” valve located on a hydraulic pump so as to move hydraulic fluid in a direction that retracts the relative arm. When the trawl door's angle of attack is lesser than desired, the control unit turns on a “Extend” signal to the extendable arm of the trawl door's attack angle altering apparatus. In this way, an ideal angle of attack is maintained during turns, cross currents, heavy loading of the trawl and other disrupting events.

To control the pitch of the trawl door, a pitch sensor constantly monitors the trawl door's pitch and either constantly or periodically sends information to the first control unit indicating the trawl door's pitch. The ideal desired pitch is programmed into the control unit. When the control unit receives information that the trawl door is pitched upwards, it sends a “Move Aft” signal to the pitch variable backstrop bracket, which also may include either a “Retract” or “Extend” command to the pertinent extendable arm (in the instant example it would be a “Retract” command). Thus, the trawl door's pitch would be moved downward.

To control the trawl door's tilt, a desired tilt and/or a desired door spread is programmed into the first control unit. A tilt sensor sends information to the control unit indicating the trawl door's tilt. When the control unit receives information that the pitch is, for example, in a “dive” orientation, it sends a signal to increase the “climb” tilt of the doors. The first and second control units may be coupled, and/or the first control unit may otherwise be coupled to an onboard sonar that reads the proximity of the trawl's footrope relative to the sea bottom, or the proximity of the trawl's headline relative to the surface, and is functioning so as to maintain the trawl, its footrope and/or its headline in a desired elevation relative to the sea floor and/or sea surface. Or, it may be controlled to likewise maintain the trawl's mouth opening at a desired elevation relative to a targeted shoal of fish indicated on the sonar. However, it is suspected that in most cases skippers shall prefer to remotely operate the trawl door's tilt, while desiring to have the trawl doors angle of attack and pitch controlled automatically.

For reliability of operation, the control units are programmed with a “Safety” mode of operation that senses when any malfunction is occurring in the trawl door attack angle altering apparatus, pitch variable backstrop bracket and tilt control apparatus. When such malfunction is detected, the Safety mode overrides other operations of the control unit and places the trawl door into a preprogrammed desired angle of attack and tilt, especially an angle of attack considered high for a particular trawl door and a tilt considered to provide a slight net climbing force for any particular trawl door.

In substitution for the attack angle altering apparatus taught herein above, though also optionally hingedly mounted to the trawl door as described supra for the trawl door attack angle altering apparatus: the disclosed trawl door may have a warp connection point that is attached to a carriage that itself is slideably mounted upon the inner side surface of the trawl door. The carriage is slideably mounted to the trawl door with a male/female rail mounting, or similar apparatus. A spring, such as a coil spring, is held in place by an apparatus constructed and configured to permit the coil spring to push aft (backward) upon the carriage upon which is mounted the warp connection point. The tension of the spring is adjusted so that during normal trawling for any particular vessel and trawl net, the spring is compressed to a preset maximal amount by allowing the carriage upon which is mounted the warp connection point to abut a stop plate. At this position is provided a certain desired angle of attack of the trawl door. Any event that decreases the force compressing the spring beyond a certain amount causes the spring to force in an aftward direction the warp connection point, thereby increasing the trawl door angle of attack, as is needed for example during turns.

FIG. 16 shows an alternative construction for an attack angle altering apparatus formed of an attack angle retractable (including extendable) arm upon which is located another moveable connection point. The attack angle retractable arm may be a screw jack, worm gear or hydraulic ram having its long dimension more in line (i.e. more near to being parallel) to the chord direction line of the main deflector than it is near to being perpendicular to the chord direction line of the main deflector.

FIG. 17 shows an alternative construction for a combination attack angle altering apparatus and tilt altering apparatus constructed of a ball and socket joint 931 and a moveable connection point situated on the inside surface of the trawl door. This assembly can also be used to control pitch by experimental determination.

In order to construct an alternate pitch control apparatus, the pitch variable backstrop bracket may also optionally have another retractable/extendable powered arm that changes the distance that one end of the backstrop bracket is positioned relative to the exterior surface of the trawl door, as can be used to alter trawl door pitch. A hinge would need to be located at the other end of the backstrop bracket to hingeably affix that end of the backstrop bracket to the trawl door. For example, the hinge may be hidden within the profile body or located on the inner side surface of the trawl door, at the forward end of a backstrop bracket, while a hydraulic powered ram extends and retracts the aft end of the backstrop bracket further from and closer to the trawl door.

For trawl doors of the present disclosure where plate thickness is insufficient to permit creating a cavity to enclose machinery such as a hydraulic motor, the high support for the high strength hinge, the slit forming plates, a battery power source, hydraulic lines, information and energy conductors and the like, a hollow body that is hydrofoil shaped may be located centrally between upper and lower portions of the trawl door to serve such purpose.

In reference to FIG. 1 and FIG. 2: Due to unprecedented dynamic forces generated by the trawl door of the present disclosure, it is important that the connection point for the main towing warp 74 be positioned closer to the upper edge of the trawl door, as shown formed of upper end plate 48B than to the lower edge of the trawl door, as shown formed of lower end plate 48A. This becomes especially useful both when the trawl door has a dihedral shape as taught herein, and also when the aspect ratio of the trawl door exceeds 2:1 (two to one), and yet more critically when such aspect ratio exceeds 2.2:1, and even yet more critically when such aspect ratio exceeds 2.4:1, exceeds 2.55:1 and exceeds 2.7:1. Furthermore, due to the unpredictability of the unprecedented hydrodynamic forces generated by the trawl door of the present disclosure, it is highly preferred that the trawl door provide many options to the fishermen permitting varying the position of the connection point to the main towing warp so as to permit raising or lowering such connection point, i.e. moving it closer to or farther from the upper end plate, and also to permit moving it both in the vertical and horizontal planes.

FIG. 1 shows a side plan view of the inner side of the trawl door having main bale 301. The main bale includes several apertures (holes) 303 to which the main towing warp is connected, usually via a terminal length of chain having at its distal end a shackle that connects to the bale. Thus, the connection point is at whatever aperture 303 is selected. Shown are two holes above the center plate, one hole level with the center plate, and one hole beneath the center plate. However, up to three, four, five, six, seven, eight, nine or even ten or more holes 303 may be situated above the center plate, i.e. are situated closer to the upper end plate than to the lower end plate. Varying the connection of the towing warp relative to the body of the trawl door in the vertical plane is accomplished by selecting a hole 303, while varying the front to back, i.e. horizontal location of the connection point relative to the body of the trawl door is accomplished by alternately moving heavy duty pin bolt 306 to occupy differing holes 304, until a preferred trawl net spread, preferred drag and desired stability are obtained for a particular fishing depth, scope of main warp, rigging parameters and other conditions. Generally, for any particular trawl and vessel, several hours of initial experimentation are required when first using a trawl door of the present disclosure, after which the settings are determined and reused.

When the trawl door of the present disclosure is a Vee shaped trawl door, as shown in FIG. 2, which is a front plan view of a trawl door of the present disclosure, it is additionally preferred that not only does the trawl door include several connection holes 303 situated nearer to the upper end plate than to the lower end plate and as well several holes 304, so as to permit altering both the vertical as well as the horizontal point of the connection of the towing warp to the trawl door, but also it is highly preferred that the distance from the center plate 72 to lower end plate 48A is greater than the distance from the center plate 72 to upper end plate 48B. It shall be recalled that a Vee shaped trawl door includes a dihedral shape, that can have either upper and lower trawl door sections lying in different planes, with or without additional trawl door sections that may also lie in different planes or that may lie in a same plane. For example, the upper and lower trawl door sections may be joined by another trawl door section also having at least a main deflector body, where all three mentioned trawl door sections lie in different planes.

In further reference to FIG. 1 and FIG. 2, it is highly important for preferred embodiments of the present disclosure that a longitudinal axis indicated by imaginary straight line 308 intersecting and parallel to the leading edge of an upper section of the disclosed trawl door lie within a plane that when the trawl door is viewed in a side plan view, as shown in FIG. 1, is a same plane as lies a longitudinal axis indicated by imaginary straight line 310 intersecting and parallel to the leading edge of a lower section of the disclosed trawl door, whether there are two or more trawl door sections, and whether or not the preferred Vee shape is used. Thus, “upper and lower leading edge relationship angle 316” preferably has a value of 180 degrees (one hundred eighty degrees). However, in some embodiments, this angle may be from 170 degrees to 188 degrees, i.e. for a “forward swept upper and lower section relationship” or for a “swept back upper and lower section relationship” embodiment of the present disclosure. However, as mentioned supra, it is most preferred that this angle is 180 (one hundred eighty) degrees, or at least within 6% of 180 degrees, and preferably within 5% of one hundred eighty degrees, and more preferably within 4% of one hundred eighty degrees, and yet more preferably within 3%, yet again more preferably within 2%, and yet again more preferably within 1% of one hundred eighty degrees.

Similarly, in respect to the trailing edge of the disclosed trawl door, it is highly advantageous for preferred embodiments of the present disclosure that a longitudinal axis indicated by imaginary straight line 312 intersecting and parallel to the trailing edge of an upper section of the disclosed trawl door lie within a plane that when the trawl door is viewed in a side plan view, as shown in FIG. 1, is a same plane as lies a longitudinal axis indicated by imaginary straight line 314 intersecting and parallel to the trailing edge of a lower section of the disclosed trawl door, whether there are two or more trawl door sections, and whether or not the preferred Vee shape is used. Thus, “upper and lower trailing edge relationship angle 318” preferably has a value of 180 degrees (one hundred eighty degrees). However, in some embodiments, this angle may be from 188 degrees to 170 degrees, i.e. for a “forward swept upper and lower section relationship” or for a “swept back upper and lower section relationship” embodiment of the present disclosure. However, as mentioned supra, it is most preferred that this angle is 180 (one hundred eighty) degrees, or at least within 6% of 180 degrees, and preferably within 5% of one hundred eighty degrees, and more preferably within 4% of one hundred eighty degrees, and yet more preferably within 3%, yet again more preferably within 2%, and yet again more preferably within 1% of one hundred eighty degrees.

In further reference to FIG. 2, upper and lower trawl door edges, in the instant example formed from upper and lower end plates, may include end plates that both (i) project outward from the profile of the primary lift generating portion of the trawl door; (ii) lie in planes that are parallel to one another or that are within 19 degrees of being parallel to one another; and (iii) include an upper end plate lying in a plane that forms with a plane within which lies the upper trawl door section an angle of lesser than ninety degrees (i.e. an acute angle), when measured on a side of the divergence and/or convergence of such planes including the majority of the trawl door (with the lower end plate lying in a plane preferably parallel to the plane within which lies the upper end plate, or at least within 4 degrees of being so parallel).

In further reference to FIG. 2, especially in seismic applications trawl doors of the present disclosure may be connected to a main towing warp at door bridle connection point 331 using two each of upper and lower door bridle strops 332 and 334, respectively, where the upper door bridle strops are of a shorter length than the lower door bridle strops. The upper and lower door bridle strops connect to or near to upper and lower end plates and/or upper and lower edges of the trawl door, respectively, at the fore and aft locations and also to the door bridle connection point. Additionally, and not shown so as to not clutter the drawing, a pair of middle door bridle strops connects the door bridle connection point to the trawl doors center plate 72. There are two or three each of the upper and lower door bridle strops and of the middle door bridle strops, connected at least to the upper front and aft edge of a trawl door upper end plate and/or other plate and/or upper edge; to the front and aft edge of a trawl door lower end plate and/or other trawl door plate and/or lower edge; and to the trawl door's center plate, respectively. By having the upper door bridle strops shorter than the lower door bridle strops, the connection point of the trawl door to the seismic towing warp (i.e. superwide, paravane line or other) is maintained nearer to the surface of the body of water within which is deployed the present disclosure, reducing the amount of the seismic towing warp that is submerged within such body of water, thereby reducing its drag and concurrent fuel usage.

In order to set and dock trawl doors of the present disclosure for seismic applications, a moveable/retractable trawl door bunker including at least an upper and lower bumper as well as a suitably mounted sheave located centrally in between the upper and lower bumpers and removed *inboard (i.e. away from the trawl door and toward the vessel) of the upper and lower bumpers, is employed. The moveable/retractable trawl door bunker preferably is attached to the end of a crane arm that is able to be folded onto the deck with or without the door locked into the bunker, and able to be remotely extended and/or “unfolded” so as to position the trawl door into the body of water within which is operating the vessel, at a safe distance from the vessel so as to preclude vessel damage from impacts with the trawl door and also so as to allow the trawl door to be safely launched (i.e. “set”) and also retrieved (i.e. “docked”). In order to retrieve the trawl door, the bunker is extended outboard and positioned so as to have the towing warp pass through its sheave. Then, the towing warp is withdrawn until the trawl door is pulled firmly against the bumpers of the bunker. Then, remotely controlled arms embrace the trawl door and press it firmly against the bumpers of the bunker. Then, the entire bunker mounted on the extendable/foldable crane arm is raised and withdrawn so as to be folded either against a side of the vessel or so as to be folded and laid onto a deck of the vessel.

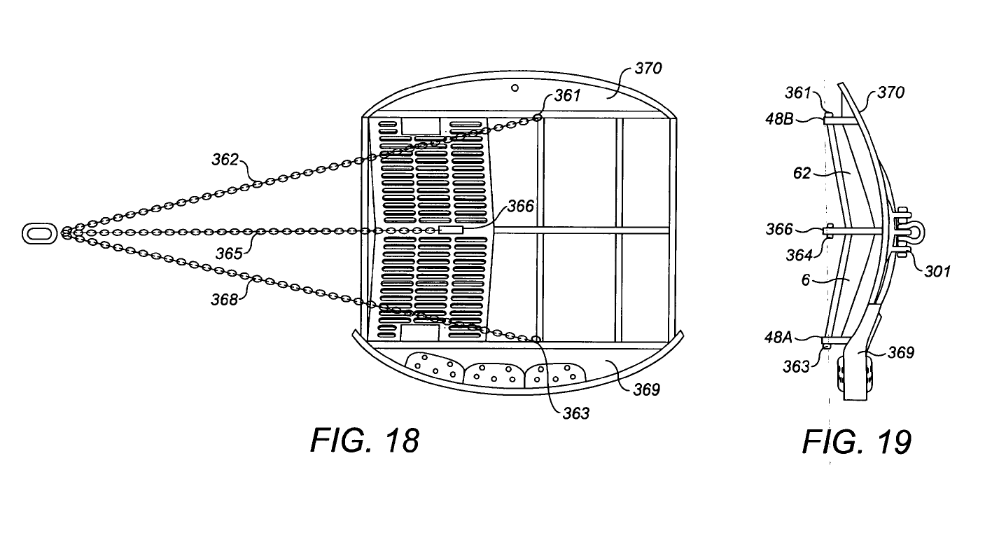

In reference to FIG. 18 and FIG. 19: When a trawl door of the present disclosure has an aspect ratio lower than 2:1, as well as in other aspect ratios, but especially when an aspect ratio also is lower than 1.2:1, lower than 1:1, lower than 0.8:1, lower than 0.7:1 and lower than 0.6:1, it is especially important that the trawl door be configured so as to be adaptable for center rigging, as known in the art.

As shown in FIGS. 29 and 30: In such embodiments, the instant disclosure teaches a trawl door having in combination:

a dihedral shape (i.e. including at least upper and lower sections lying in differing planes);

at least one steering back strop connection point that is an upper steering back strop connection point 361 designed and configured for attachment to at least one upper steering back strop 362;

a center back strop connection point 364 designed and configured for attachment to a centrally located back strop 365, the center back strop connection point supported by a rigid back strop fin 366 and situated further outboard from the outer side surface of the trawl door's main deflector than is situated the at least one steering back strop connection point.

The trawl door further includes a main bale (including main bracket, see also FIG. 1 and FIG. 2) designed and configured for attachment to a trawler's warp, wherein the main bale includes warp attachment points that are situated a different distance from the upper edge of the primary lift generating portion of the trawl door than from the lower edge of the primary lift generating portion of the trawl door.

Further ideally, the trawl door of such embodiment

Includes a second steering back strop connection point that is lower steering backstrop connection point 363, one of the at least two steering back strop connection points situated nearer the upper edge of the primary lift generating portion of the trawl door than is the center back strop connection point, and the other of the at least two steering back strop connection points situated nearer the lower edge of the primary lift generating portion of the trawl door than is the center back strop connection point.

In such embodiments, it is useful that the center back strop connection point is situated more proximal to the most aft portion of the trailing edge of the trawl door than is situated the at least one steering back strop connection point.

It is understood that weight shoe structure 369 and upper bumper 370 are not a as part of the primary lift generation portion of the trawl door.

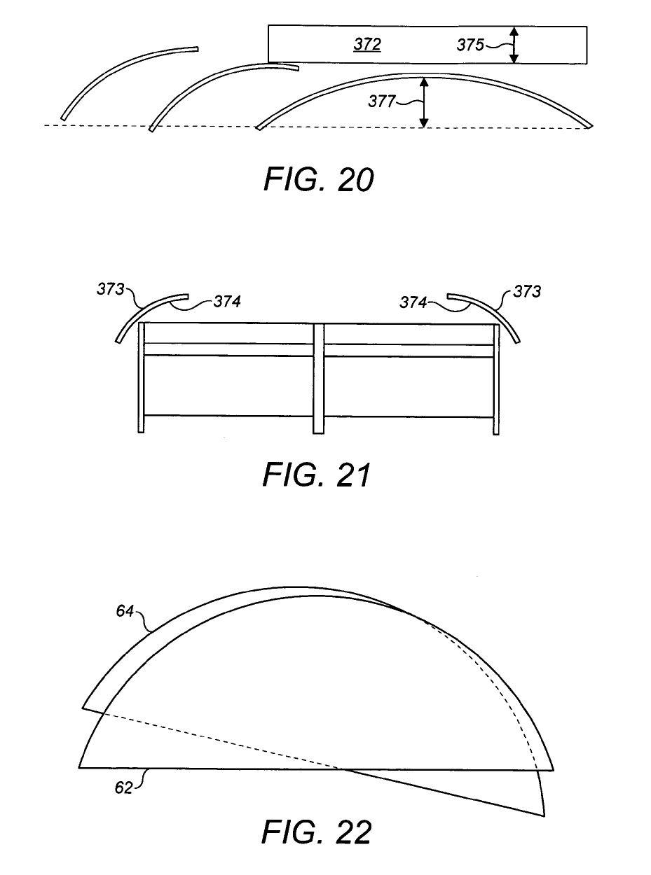

In reference to FIG. 20 and FIG. 21: FIG. 20 is atop plan view of an alternative embodiment of profile of the trawl door of the present disclosure, while FIG. 21 is a rear plan view of the same trawl door shown in FIG. 20. In order to not clutter the drawing, other disclosed features of the disclosed trawl door that are not particular taught in reference to FIGS. 20 and 21 are not shown.

FIG. 20 shows a side slat 372 situated adjacent to the outer side surface of the trawl door of the present disclosure. The side slat preferably extends from forward or near the trailing edge of a leading edge slat, such as from forward of the trailing edge of a trailing leading edge slat, and adjacent to the outer side surface of same trailing leading edge slat, toward and to and/or near the trailing edge of the trawl door and/or trailing edge of the main deflector. The side slat's overall length is preferably from 3/7^{th} to 6/7^{th} the length of the trawl door, with from 3.7/7^{th} to 4/7^{th} presently preferred. However, in some embodiments the side slat may extend from the leading to trailing edges of the trawl door, or even from forward of the trawl door's leading edge to the trawl door's trailing edge, or even to aft of the trawl door's trailing edge.

As shown in FIG. 21, preferably there are two side slats, one each located on or near the upper and lower edges of the primary lift generating portion of the trawl door. The side slats have a concave profile and are formed of bent steel plate or other suitable material, with smooth surfaces. The concave profile may be formed from an arc of a circle, or may be any other concave shape as experimentally determined useful. For example, the concave profile may be “C” shaped, “U” shaped, “G” shaped, “V” shaped or other. The side slats' concave profile includes an outer convex side facing outboard of the trawl door (i.e. facing away from the outer side surface of the trawl door), and a inner concave side facing inboard (i.e. facing toward the inner side surface of the trawl door). The side slats' width 375 is from 5% to 250% the main deflector's width 377, and preferably from 50% to 80% of such main deflector's width.

FIG. 22 is a top plan view of yet another alternative embodiment of a trawl door of the present disclosure. As shown in a purely illustrative fashion, trawl door upper and lower sections 62 and 64, respectively, may have differing angles of attack. In particular, trawl door upper section 62 can have a main deflector that has a different angle of attack than another main deflector that is a part of trawl door lower section 64.

In one such embodiment, not shown, the disclosed trawl door includes at least three different sections: the upper trawl door section, the lower trawl door section, and a middle trawl door section positioned between the upper and lower trawl door sections. In such embodiment, the middle trawl door section and/or it's main deflector has an angle of attack that is lesser than the angle of attack of the upper and lower trawl door a sections and/or their main deflectors. Furthermore, the upper and lower trawl door sections themselves may have different angles of attack, with for example the lower trawl door section having a greater angle of attack than the upper trawl door section, while also having a lesser angle of attack than the middle trawl door section. In other embodiments, the lower trawl door section may have a greater angle of attack than both the middle and upper trawl door section, while the middle trawl door section has a greater angle of attack than the upper trawl door section. This construction has been shown useful in at least turbulent water applications and in applications where very high trawl door attack angles are incurred.

Any of the various embodiments of trawl doors of the present disclosure may be formed of what is known in the industry as “straight doors”, i.e. trawl doors that are not dihedral shaped. However, as taught herein, trawl doors of the present disclosure preferably include two or more trawl doors sections, such as a middle trawl door section and an upper and lower trawl door section, or preferably include an upper and lower trawl door section, or at least an upper and lower trawl door section, where at least the upper and lower sections lie in different planes that are neither parallel nor coplanar, with an angle of less than 180 degrees formed between the planes, and especially formed between outer side and convex surfaces of at least the main deflector bodies of at least the upper and lower trawl door sections that lie in the planes that are neither parallel nor coplanar. Whether the trawl door has only the upper and lower trawl door sections lying in the planes that are neither parallel nor coplanar, or includes other trawl door sections, it is known as a “Vee” shaped trawl door (i.e. a dihedral trawl door). In other words, the upper and lower edges of that portion of the trawl door's structure designed primarily to efficiently generate lift and/or thrust are further outboard (away from the back side of the trawl door) than is the central region of that portion of the trawl door's structure designed primarily to efficiently generate lift and/or thrust. Such embodiment in combination with the other teachings of the instant disclosure provide for a trawl door that is able to be maximally efficient and also able to be used at a maximal range of elevations in the water column, thereby accomplishing the objects of the present disclosure.

FIG. 23 shows side plan, view of a trawl door showing a useful rigging of backstops to a trawl door that provide for continuing stability of the trawl door during catastrophic rigging failure such a backstop rupture and/or the rupture of a bridle (including “sweep”) that is connected to a such backstop. This arrangement of backstops is known as a “W rig”.

### INDUSTRIAL APPLICABILITY

In addition to the uses mentioned above, the construction and the profile for the disclosed trawl door may also be used in airfoils, such as for airplanes including cargo, light and heavy aircraft, recreational, model airplanes, helicopter propeller blades, turbine blades and any other airfoil applications. Several of the disclosed profiles may be useful in forming propeller blades and propeller apparatuses and assemblies for propulsion of water craft. Additionally, the trawl doors of the present disclosure are useful for spreading any towed in water apparatus and elements, including for mine removal and/or mine sweeping, underwater surveying and mapping, underwater monitoring of equipment, facilities and resources, and for spreading apart commercial and recreational trolling equipment, including for surface fishing of big game recreational species, and the like. Consequently, without departing from the spirit and scope of the disclosure, various alterations, modifications, and/or alternative applications of the disclosure appear likely to be suggested to those skilled in the art after having read the preceding disclosure. Accordingly, it is intended that the following claims be interpreted as encompassing all alterations, modifications, or alternative applications as fall within the true spirit and scope of the disclosure.

1-70. (canceled)

71. A trawl door (10) for use with a trawl net, the trawl door (10) having leading and trailing edges (12, 14), at least an upper section (28) and at least a lower section (29), the at least an upper section (28) having at least a main deflector body (24) and the at least a lower section (29) having at least a main deflector body (25), the at least an upper section's main deflector body (24) having an outer side convex surface (56, 228) and the at least a lower section's main deflector body (25) having an outer side convex surface (56, 228), each main deflector body (24, 25) having a leading edge (42) and a trailing edge (14), the trawl door having:
(i) a forward leading edge slat (20) and a trailing leading edge slat (22), the forward leading edge slat (20) having a leading edge (12) and a trailing edge (36), and the trailing leading edge slat (22) having a leading edge (38) and a trailing edge (40); and
(ii) a profile for at least a portion of the trawl door where the forward leading edge slat (20) and the trailing leading edge slat (22) each have their respective leading edge disposed forward of the leading edge of a main deflector body and each have an acute angle, the forward leading edge slat's angle made by a convergence of:
(a) a first imaginary straight line (81) connecting leading and trailing edges (12, 36) of the forward leading edge slat (20); and
(b) a second imaginary straight line (88) joining leading and trailing edges (42, 14) of the main deflector body, and the trailing leading edge slat's angle made by a convergence of:
(1) a first imaginary straight line (82) connecting leading and trailing edges (38, 40) of the trailing leading edge slat (22); and
(2) the second imaginary straight line (88) joining leading and trailing edges (42, 14) of the main deflector body;
the trawl door characterized in that in combination:
(iii) the trawl door has an aspect ratio being over 2:1;
(iv) the portion of the trawl door having the profile is configured so that:
(a) the angle of the forward leading edge slat (20) is greater than the angle of the trailing leading edge slat (22);
(b) a camber for the forward leading edge slat (20) differs from and is greater than a camber of the main deflector body;
(c) the forward leading edge slat's leading edge forms the leading edge of the trawl door;
(d) the trailing edge (40) of the trailing leading edge slat (22) extends beyond a tangent plane of the main deflector body, the tangent plane being parallel to imaginary straight line (88) joining leading and trailing edges (42, 14) of the main deflector body;
(e) a distance between leading and trailing edges (42, 14) of the main deflector body is greater than a distance between leading and trailing edges (12, 36 and 38, 40) of the forward leading edge slat;
(f) the forward leading edge slat and the trailing leading edge slat are formed with different chord lengths;
(g) the trailing leading edge slat's leading edge is more proximal the main deflector body's leading edge than is the forward leading edge slat's leading edge;
(h) a value of an acute angle made by a divergence of a line (83) joining leading and trailing edges (12, 14) of the trawl door from the line (88) joining leading and trailing edges (42, 14) of the main deflector body is a value greater than zero;
(i) the camber of the forward leading edge slat is greater than the camber of the trailing leading edge slat; and
(j) the angle of the at least a forward leading edge slat (20) is at least thirty-two degrees,
whereby trawl door efficiency is enhanced.

72. The trawl door (10) according to claim 71 wherein the aspect ratio is selected from a group consisting of:
(a) over 2.4:1;
(b) at least 2.5:1;
(c) at least 2.7:1;
(d) at least 2.75:1; and
(e) at least 3:1.

73. The trawl door (10) according to claim 72 wherein the portion of the trawl door having the profile is configured so that at least one of the slats has a cross-sectional shape being selected from a group consisting of:
(1) a cross-sectional shape including a cambered inner surface (53);
(2) a cross-sectional shape including an arc of a circle;
(3) a cross-sectional shape where at least a portion of the at least one slat's inner and outer surfaces (53, 54) have the same curvature; and
(4) a cross-sectional shape which corresponds to a portion of a cross sectional shape of the main deflector body (24, 25), and
the main deflector body (24, 25) includes a profile being selected from a group consisting of:
(a) a profile having a concave cambered inner side (229);
(b) a profile having an airfoil shape;
(c) a profile having both concave and convex surfaces of different shape; and
(d) a profile including a convex outer side and a concave inner side and the widest point of the profile is located front of centre of the profile's chord.

74. The trawl door (10) according to claim 72 wherein the trawl door is configured so that a radius of a profile of a portion of the trawl door being selected from a group consisting of:
(a) the portion of the trawl door being the main deflector body; and
(b) the portion of the trawl door being the trailing leading edge slat (22), is a radius that is within 5% of being ½ of the width of the trawl door (10).

75. The trawl door (10) according to claim 72 wherein the portion of the trawl door having the profile is configured so that a distance between the leading edge of the forward leading edge slat (20) and the leading edge of the main deflector body (24, 25) is within 7% of being ⅓ of the distance of the width of the trawl door (10).

76. The trawl door (10) according to claim 72 wherein the portion of the trawl door having the profile is configured so that the camber of the forward leading edge slat is greater than the camber of the trailing leading edge slat.

77. The trawl door (10) according to claim 72 wherein the portion of the trawl door having the profile is configured so that a shortest distance between the inner side surface of the forward leading edge slat and the outer side surface of the forward leading edge slat is lesser than a shortest distance between the inner side surface of the main deflector body and the outer side surface of the main deflector body.

78. The trawl door (10) according to claim 72 wherein the portion of the trawl door having the profile is configured so that a shortest distance between the inner side surface of the forward leading edge slat and the outer side surface of the forward leading edge slat is lesser than a shortest distance between the inner side surface of the trailing leading edge slat and the outer side surface of the trailing leading edge slat.

79. The trawl door (10) according to claim 72 wherein the portion of the trawl door having the profile is configured so that the slats are formed with similar camber to their outer and inner side surfaces.

80. The trawl door (10) according to claim 72 wherein the portion of the trawl door having the profile is configured so that the main deflector body is formed with similar camber to its outer and inner side surfaces.

81. The trawl door (10) according to claim 72 wherein the portion of the trawl door having the profile is configured so that the slats are formed with a bent sheet shape.

82. The trawl door (10) according to claim 72 wherein the portion of the trawl door having the profile is configured so that the trailing edges of the forward and trailing leading edge slats extend beyond a tangent plane of the main deflector body, the tangent plane being parallel to imaginary straight line (88) joining leading and trailing edges (42, 14) of the main deflector body.

83. The trawl door (10) according to claim 72 wherein the portion of the trawl door having the profile is configured so that the first and trailing leading edge slats are formed with differ-ent chord lengths, and the chord length of the forward leading edge slat being lesser than the chord length of the trailing leading edge slat, the forward leading edge slat being a forward leading edge slat and the trailing leading edge slat being a trailing leading edge slat.

84. The trawl door (10) according to claim 72 wherein the portion of the trawl door having the profile is configured so that the first and trailing leading edge slats are formed with differ-ent chord lengths, and the chord length of the forward leading edge slat being longer than the chord length of the trailing leading edge slat.

85. The trawl door (10) according to claim 72 wherein the portion of the trawl door having the profile is configured so that the leading edge of the forward leading edge slat lies above the axis of imaginary straight line (88) joining leading and trailing edges of the main deflector body.

86. The trawl door (10) according to claim 72 wherein the portion of the trawl door having the profile is configured so that the leading edge of the trailing leading edge slat lies above the axis of imaginary straight line (88) joining leading and trailing edges of the main deflector body.

87. The trawl door (10) according to claim 72 wherein the portion of the trawl door having the profile is configured so that the leading edges of the forward and trailing leading edge slats lie above the axis of imaginary straight line (88) joining leading and trailing edges of the main deflector body.

88. The trawl door (10) according to claim 87 wherein the portion of the trawl door having the profile is configured so that the leading edges of the forward and trailing leading edge slats lie above the axis of imaginary straight line (88) joining leading and trailing edges of the main deflector body, and lie different distances above the axis of imaginary straight line (88) joining leading and trailing edges of the main deflector body.

89. The trawl door (10) according to claim 87 wherein the portion of the trawl door having the profile is configured so that the leading edges of the forward and trailing leading edge slats lie above the axis of imaginary straight line (88) joining leading and trailing edges of the main deflector body, and lie different distances above the axis of imaginary straight line (88) joining leading and trailing edges of the main deflector body, and the leading edge of the forward leading edge slat lies further above the axis of imaginary straight line (88) than lies the leading edge of the trailing leading edge slat.

90. The trawl door (10) according to claim 87 wherein the portion of the trawl door having the profile is configured so that the leading edges of the forward and trailing leading edge slats lie above the axis of imaginary straight line (88) joining leading and trailing edges of the main deflector body, and lie different distances above the axis of imaginary straight line (88) joining leading and trailing edges of the main deflector body, and the leading edge of the trailing leading edge slat lies further above the axis of imaginary straight line (88) than lies the leading edge of the forward leading edge slat.
